(19) United States
(12) Patent Application Publication
(10) Pub. No.: US 2022/0312019 A1
(43) Pub. Date: Sep. 29, 2022

(54) DATA PROCESSING DEVICE AND COMPUTER-READABLE RECORDING MEDIUM STORING DATA PROCESSING PROGRAM

(71) Applicant: FUJITSU LIMITED, Kawasaki-shi (JP)

(72) Inventors: Tomonori KUBOTA, Kawasaki (JP); Takanori Nakao, Kawasaki (JP); Yasuyuki Murata, Shizuoka (JP)

(73) Assignee: FUJITSU LIMITED, Kawasaki-shi (JP)

(21) Appl. No.: 17/838,321

(22) Filed: Jun. 13, 2022

Related U.S. Application Data
(63) Continuation of application No. PCT/JP2020/003785, filed on Jan. 31, 2020.

(51) Int. Cl. H04N 19/154; G06V 10/70; H04N 19/176; H04N 19/124; H04N 19/85; G06V 10/98

(52) U.S. Cl. CPC H04N 19/154; G06V 10/70; H04N 19/176; H04N 19/124; H04N 19/85; G06V 10/993

(57) ABSTRACT

A data processing device includes: a memory; and a processor coupled to the memory and configured to: in a case where a compression level is designated based on a degree of influence of each block on a recognition result when a recognition process is performed on image data, generate compressed data by performing a compression process on the image data by using the compression level; and in a case where the recognition result when the recognition process is performed on decoded data obtained by decoding the compressed data satisfies a predetermined condition, correct a block that corresponds to a recognition target, in a direction of raising the compression level.

### CROSS-REFERENCE TO RELATED APPLICATION

This application is a continuation application of International Application PCT/JP2020/003785 filed on Jan. 31, 2020 and designated the U.S., the entire contents of which are incorporated herein by reference.

### FIELD

The embodiments discussed herein are related to a data processing device and a data processing program.

### BACKGROUND

Commonly, when image data is recorded or transmitted, the reduction of the recording cost and transmission cost is achieved by performing a compression process on the image data and making the data size smaller.

Japanese Laid-open Patent Publication No. 2018-101406, Japanese Laid-open Patent Publication No. 2019-079445, and Japanese Laid-open Patent Publication No. 2011-234033 are disclosed as related art.

### SUMMARY

According to an aspect of the embodiments, a data processing device includes: a memory; and a processor coupled to the memory and configured to: in a case where a compression level is designated based on a degree of influence of each block on a recognition result when a recognition process is performed on image data, generate compressed data by performing a compression process on the image data by using the compression level; and in a case where the recognition result when the recognition process is performed on decoded data obtained by decoding the compressed data satisfies a predetermined condition, correct a block that corresponds to a recognition target, in a direction of raising the compression level.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating an example of the system configuration of a compression processing system;

FIG. 2 is a diagram illustrating an example of the hardware configuration of an analysis device, an image compression device, or a data processing device;

FIG. 3 is a diagram illustrating an example of the functional configuration of the analysis device;

FIG. 4 is a diagram illustrating a specific example of an aggregation result;

FIG. 5 is a diagram illustrating a specific example of processing by a quantization value designation unit;

FIG. 6 is a diagram illustrating a specific example of processing by a foreground determination unit;

FIG. 7 is a diagram illustrating an example of the functional configuration of the image compression device;

FIG. 8 is a first diagram illustrating an example of the functional configuration of the data processing device;

FIG. 9 is a diagram illustrating a specific example of processing of a quantization value correction unit;

FIG. 10 is a first flowchart illustrating an example of the flow of an image compression process by the compression processing system;

FIG. 11 is a second diagram illustrating an example of the system configuration of a compression processing system;

FIG. 12 is a second diagram illustrating an example of the functional configuration of a data processing device;

FIG. 13 is a first diagram illustrating a specific example of processing of an analysis unit;

FIG. 14 is a second diagram illustrating a specific example of processing of the analysis unit;

FIG. 15 is a second flowchart illustrating an example of the flow of an image compression process by a compression processing system;

FIG. 16 is a third diagram illustrating an example of the system configuration of a compression processing system;

FIG. 17 is a fourth diagram illustrating an example of the system configuration of the compression processing system;

FIG. 18 is a third diagram illustrating an example of the functional configuration of a data processing device;

FIG. 19 is a third flowchart illustrating an example of the flow of an image compression process by a compression processing system;

FIG. 20 is a fifth diagram illustrating an example of the system configuration of a compression processing system;

FIG. 21 is a sixth diagram illustrating an example of the system configuration of the compression processing system;

FIG. 22 is a fourth diagram illustrating an example of the functional configuration of a data processing device; and

FIG. 23 is a fourth flowchart illustrating an example of the flow of an image compression process by a compression processing system.

### DESCRIPTION OF EMBODIMENTS

Meanwhile, in recent years, there have been an increasing number of cases in which image data is recorded or transmitted for the purpose of being utilized for a recognition process by artificial intelligence (AI). As a representative model of AI, for example, a model using deep learning or machine learning can be cited.

However, the past compression process is performed based on the human visual characteristics and is not performed based on the motion analysis of AI. For this reason, there have been cases where the compression process is not performed at a sufficient compression level for the area that is not involved in the recognition process by AI. Alternatively, there have been cases where the image quality of an important area in the recognition process by AI is deteriorated, and sufficient recognition accuracy is not obtained when decoded.

In one aspect, an object is to implement a compression process suitable for a recognition process by AI.

Hereinafter, each embodiment will be described with reference to the accompanying drawings. Note that, in the present specification and the drawings, constituent elements having substantially the same functional configuration are denoted by the same reference sign, and redundant description will be omitted.

### First Embodiment

<System Configuration of Compression Processing System>

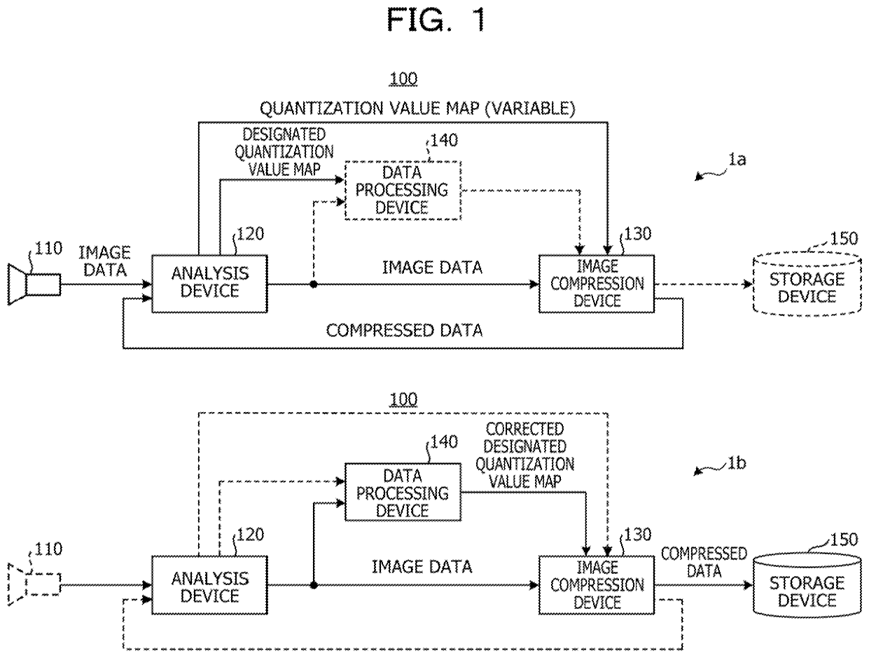

First, a system configuration of the entire compression processing system including a data processing device according to a first embodiment will be described. FIG. 1 is a first diagram illustrating an example of the system configuration of the compression processing system. In the first embodiment, the processing executed by the compression processing system can be roughly divided into:

a first phase of generating a designated quantization value map; and

a second phase of correcting the designated quantization value map, performing a compression process using the corrected designated quantization value map, and storing compressed data.

In FIG. 1, a system configuration of the compression processing system in the first phase is indicated by 1a, and a system configuration of the compression processing system in the second phase is indicated by 1b.

As illustrated in 1a of FIG. 1, the compression processing system 100 in the first phase includes an imaging device 110, an analysis device 120, and an image compression device 130.

The imaging device 110 captures an image at a predetermined frame period and transmits image data to the analysis device 120. Note that the image data includes an object that is a recognition target.

The analysis device 120 includes a learned model that performs a recognition process. The analysis device 120 performs the recognition process by inputting image data to the learned model and outputs a recognition result.

In addition, the analysis device 120 acquires each piece of compressed data output by the image compression device 130 performing a compression process on the image data at different compression levels (quantization values), and generates each piece of decoded data by decoding each piece of the compressed data. Furthermore, the analysis device 120 performs the recognition process by inputting each piece of the decoded data to the learned model and outputs a recognition result.

In addition, the analysis device 120 generates a map (referred to as an important feature map) indicating the degree of influence on the recognition result, by performing motion analysis for the learned model at the time of the recognition process, using, for example, an error back propagation method. Furthermore, the analysis device 120 aggregates the degree of influence for each predetermined area (for each block used when the compression process is performed) based on the important feature map.

Note that, by sequentially transmitting a quantization value map (variable) in which the quantization value is set in each block to the image compression device 130, the analysis device 120 instructs the image compression device 130 to perform the compression process at different compression levels (quantization values).

In addition, the analysis device 120 generates an aggregated value graph for each block, based on the aggregated value of the degree of influence of each block aggregated each time the recognition process is performed on each piece of the decoded data. The aggregated value graph is a graph indicating changes in the aggregated value with respect to each compression level (each quantization value). In addition, the analysis device 120 designates an optimum compression level (quantization value) of each block, based on each of the aggregated value graphs for each block.

Hereinafter, the optimum quantization value of each block designated by the analysis device 120 will be referred to as “designated quantization value”. In addition, a map in which the designated quantization value is set in each block will be referred to as “designated quantization value map”. Note that the analysis device 120 transmits the designated quantization value map to a data processing device 140.

In this manner, according to the analysis device 120, by performing the motion analysis for the learned model and aggregating the degree of influence on the recognition result for each block, a compression level suitable for the recognition process may be designated when the compression process is performed on the image data.

Meanwhile, as illustrated in 1b of FIG. 1, the compression processing system 100 in the second phase includes the analysis device 120, the image compression device 130, the data processing device 140, and a storage device 150.

In the second phase, the analysis device 120 transmits the image data to the image compression device 130 and the data processing device 140.

The data processing device 140 performs the compression process on the image data transmitted from the analysis device 120, using the designated quantization value map transmitted from the analysis device 120 in the first phase. In addition, the data processing device 140 outputs the recognition result by decoding the compressed data and performing the recognition process on the decoded data.

In addition, the data processing device 140 performs the recognition process on each piece of the decoded data while increasing or decreasing the quantization value of a block corresponding to the object that is a recognition target, among the quantization values set in the respective blocks in the designated quantization value map, on a predetermined increment basis. Furthermore, the data processing device 140 compares a permissible range of the recognition result predefined based on the recognition result of the image data and the recognition result of each piece of the decoded data and searches for a maximum quantization value that allows the recognition result falling within the defined permissible range to be output.

In addition, the data processing device 140 corrects the quantization value of the block corresponding to the object in the designated quantization value map, using the maximum quantization value found by the search, and generates the corrected designated quantization value map. Furthermore, the data processing device 140 transmits the corrected designated quantization value map that has been generated to the image compression device 130.

The image compression device 130 performs the compression process on the image data, using the corrected designated quantization value map that has been transmitted, and stores the compressed data in the storage device 150.

In this manner, when the analysis device 120 generates the designated quantization value map based on the degree of influence of each block on the recognition result, the data processing device 140 according to the first embodiment corrects the quantization value of the block corresponding to the object that is a recognition target, based on the recognition result.

Consequently, according to the data processing device 140 according to the first embodiment, the compression level may be improved while the recognition result is maintained. For example, according to the data processing device 140 according to the first embodiment, a compression process suitable for the recognition process by AI may be implemented.

<Hardware Configuration of Analysis Device, Image Compression Device, or Data Processing Device>

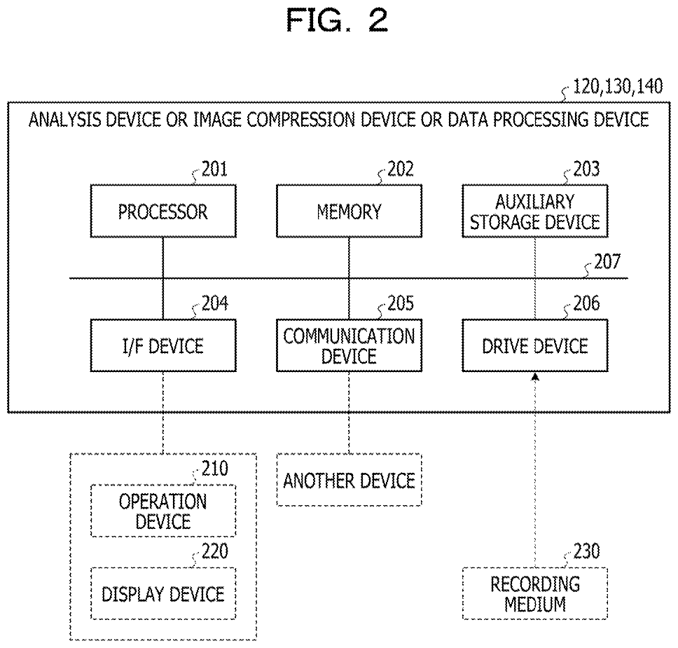

Next, a hardware configuration of the analysis device 120, the image compression device 130, and the data processing device 140 will be described. Note that, since the analysis device 120, the image compression device 130, and the data processing device 140 have similar hardware configurations, these devices will be collectively described here with reference to FIG. 2.

FIG. 2 is a diagram illustrating an example of the hardware configuration of the analysis device, the image compression device, or the data processing device. The analysis device 120, the image compression device 130, or the data processing device 140 includes a processor 201, a memory 202, an auxiliary storage device 203, an interface (I/F) device 204, a communication device 205, and a drive device 206. Note that the respective pieces of hardware of the analysis device 120, the image compression device 130, or the data processing device 140 are interconnected via a bus 207.

The processor 201 includes various arithmetic devices such as a central processing unit (CPU) and a graphics processing unit (GPU). The processor 201 reads various programs (such as an analysis program, an image compression program, or a data processing program described later, as an example) into the memory 202 and executes the read programs.

The memory 202 includes a main storage device such as a read only memory (ROM) and a random access memory (RAM). The processor 201 and the memory 202 form a so-called computer. The processor 201 executes various programs read into the memory 202 to cause the computer to implement various functions (details of the various functions will be described later).

The auxiliary storage device 203 stores various programs and various pieces of data used when the various programs are executed by the processor 201.

The I/F device 204 is a connection device that connects an operation device 210 and a display device 220, which are examples of external devices, with the analysis device 120, the image compression device 130, or the data processing device 140. The I/F device 204 receives an operation for the analysis device 120, the image compression device 130, or the data processing device 140 via the operation device 210. In addition, the I/F device 204 outputs a result of processing by the analysis device 120, the image compression device 130, or the data processing device 140 and displays the result via the display device 220.

The communication device 205 is a communication device for communicating with another device. In the case of the analysis device 120, communication is performed with the imaging device 110, the image compression device 130, and the data processing device 140, which are other devices, via the communication device 205. In addition, in the case of the image compression device 130, communication is performed with the analysis device 120, the data processing device 140, and the storage device 150, which are other devices, via the communication device 205. Furthermore, in the case of the data processing device 140, communication is performed with the analysis device 120 and the image compression device 130, which are other devices, via the communication device 205.

The drive device 206 is a device for setting a recording medium 230. The recording medium 230 mentioned here includes a medium that optically, electrically, or magnetically records information, such as a compact disc read only memory (CD-ROM), a flexible disk, or a magneto-optical disk. Alternatively, the recording medium 230 may include a semiconductor memory or the like that electrically records information, such as a ROM or a flash memory.

Note that various programs to be installed in the auxiliary storage device 203 are installed, for example, by setting the distributed recording medium 230 in the drive device 206 and reading the various programs recorded in the recording medium 230 by the drive device 206. Alternatively, the various programs to be installed in the auxiliary storage device 203 may be installed by being downloaded from a network via the communication device 205.

<Functional Configuration of Analysis Device>

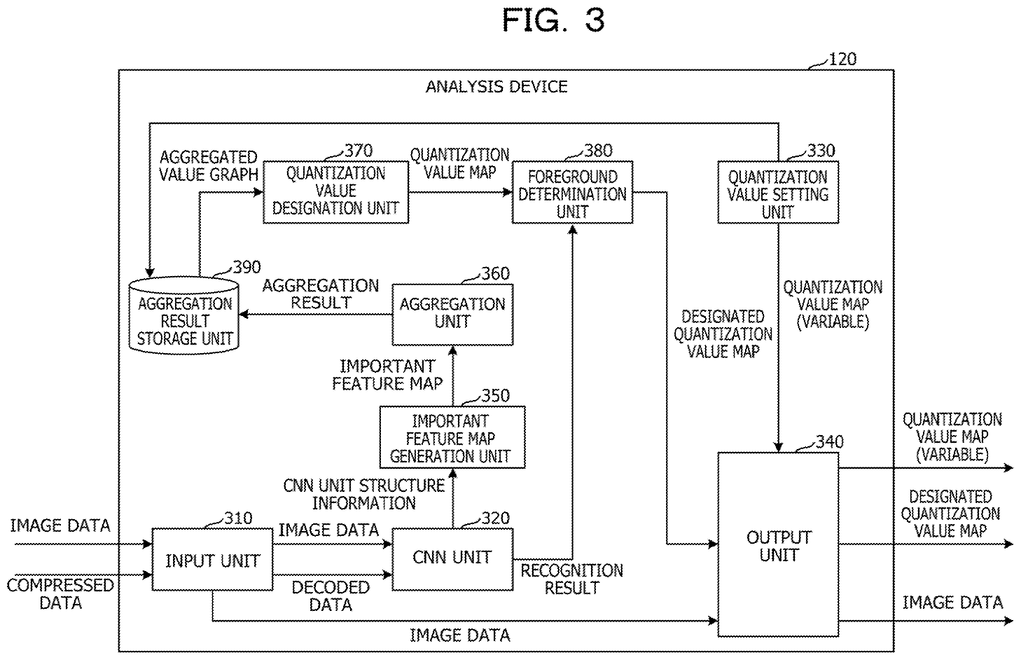

Next, a functional configuration of the analysis device 120 will be described. FIG. 3 is a diagram illustrating an example of the functional configuration of the analysis device. As described above, the analysis program is installed in the analysis device 120, and when the program is executed, the analysis device 120 functions as an input unit 310, a convolutional neural network (CNN) unit 320, a quantization value setting unit 330, and an output unit 340. In addition, the analysis device 120 functions as an important feature map generation unit 350, an aggregation unit 360, a quantization value designation unit 370, and a foreground determination unit 380.

The input unit 310 acquires image data transmitted from the imaging device 110 or compressed data transmitted from the image compression device 130. The input unit 310 notifies the CNN unit 320 and the output unit 340 of the acquired image data and decodes the acquired compressed data using a decoding unit (not illustrated) to also notify the CNN unit 320 of the decoded data.

The CNN unit 320 includes a learned model and, by inputting the image data or the decoded data, performs the recognition process on an object that is a recognition target and included in the image data or the decoded data, to output the recognition result. Note that the recognition result includes a bounding box indicating the area of the recognized object, and the CNN unit 320 notifies the foreground determination unit 380 of the bounding box.

The quantization value setting unit 330 notifies the output unit 340 sequentially of each quantization value map (variable) in which each compression level (each of quantization values from the minimum quantization value (initial value) to the maximum quantization value) used when the image compression device 130 performs the compression process is set. In addition, the quantization value setting unit 330 stores each compression level (each quantization value) that has been set, in an aggregation result storage unit 390.

The output unit 340 transmits the image data acquired by the input unit 310 to the image compression device 130. In addition, the output unit 340 sequentially transmits each quantization value map (variable) notified by the quantization value setting unit 330 to the image compression device 130. Furthermore, the output unit 340 transmits the designated quantization value map notified by the foreground determination unit 380 to the image compression device 130.

The important feature map generation unit 350 acquires CNN unit structure information when the learned model performed the recognition process on the image data or the decoded data, and generates an important feature map by utilizing an error back propagation method based on the acquired CNN unit structure information.

The important feature map generation unit 350 generates the important feature map by using, for example, a back propagation (BP) method, a guided back propagation (GBP) method, or a selective BP method.

Note that the BP method is a method in which the error of each label is computed from a classification probability obtained by performing the recognition process on image data (or decoded data) whose recognition result is the correct answer label, and the feature part is visualized by forming an image of the magnitude of a gradient obtained by back propagation to the input layer. In addition, the GBP method is a method in which the feature part is visualized by forming an image of only the positive values of the gradient information as the feature part.

Furthermore, the selective BP method is a method in which back propagation is performed using the BP method or the GBP method after leaving only the errors of the correct answer labels or after maximizing only the errors of the correct answer labels. In the case of the selective BP method, the feature part to be visualized is the feature part that affects only score information of the correct answer label.

In this manner, by using the BP method, the GBP method, or the selective BP method, the important feature map generation unit 350 analyzes the signal flow and intensity of each path in the CNN unit 320 from the input of the image data or the decoded data to the output of the recognition result. Consequently, according to the important feature map generation unit 350, it may be possible to visualize which part of the input image data or decoded data affects the recognition result to what extent (the degree of influence).

Note that, for example, when AI to which the BP method, the GBP method, or the selective BP method is not applied (or is not applicable) is used as the CNN unit 320, the important feature map generation unit 350 generates the important feature map by analyzing similar information.

Note that, for example, the method of generating the important feature map by the error back propagation method is disclosed in documents such as

“Selvaraju, Ramprasaath R., et al., “Grad-cam: Visual explanations from deep networks via gradient-based localization.”, The IEEE International Conference on Computer Vision (ICCV), 2017, pp. 618-626″.

The aggregation unit 360 aggregates the degree of influence on the recognition result in block units, based on the important feature map and calculates the aggregated value of the degree of influence for each block. In addition, the aggregation unit 360 stores the calculated aggregated value of each block in the aggregation result storage unit 390 in association with the quantization value, as the aggregation result.

The quantization value designation unit 370 designates an optimum quantization value in each block, based on the aggregated value graph of each block stored in the aggregation result storage unit 390. In addition, the quantization value designation unit 370 notifies the foreground determination unit 380 of the quantization value map in which the designated optimum quantization value is set in each block.

The foreground determination unit 380 determines a block satisfying a predetermined condition as a foreground block, among blocks contained in the bounding box notified by the CNN unit 320 and blocks located on an outer periphery of the bounding box. In addition, the foreground determination unit 380 determines a block other than the block determined to be the foreground block, as a background block. In addition, the foreground determination unit 380 maximizes the quantization value set in a block determined to be the background block, among the quantization values set in the respective blocks.

Furthermore, the foreground determination unit 380 notifies the output unit 340 of the designated quantization value map including the quantization value set in the foreground block and the quantization value (maximized quantization value) set in the background block.

Note that the method for determining the foreground block by the foreground determination unit 380 is not limited to this. For example, the foreground determination unit 380 may determine the foreground block based only on the aggregated value graph of each block, independently of the bounding box notified by the CNN unit 320. For example, the foreground determination unit 380 may determine a block whose aggregated value graph satisfies a predetermined condition as a foreground block and may determine a block whose aggregated value graph does not satisfy the predetermined condition as a background block. Alternatively, other information (such as a class classification probability as an example) may be used to determine the foreground block, independently of the bounding box.

It is arbitrary for the foreground determination unit 380 which determination method to use, and even when any determination method is used, the block located inside the bounding box may be occasionally determined as a background block.

Note that, when a determination method of determining the foreground block independently of the bounding box is used, the notification of the bounding box to the foreground determination unit 380 from the CNN unit 320 may be omitted.

<Specific Example of Aggregation Result>

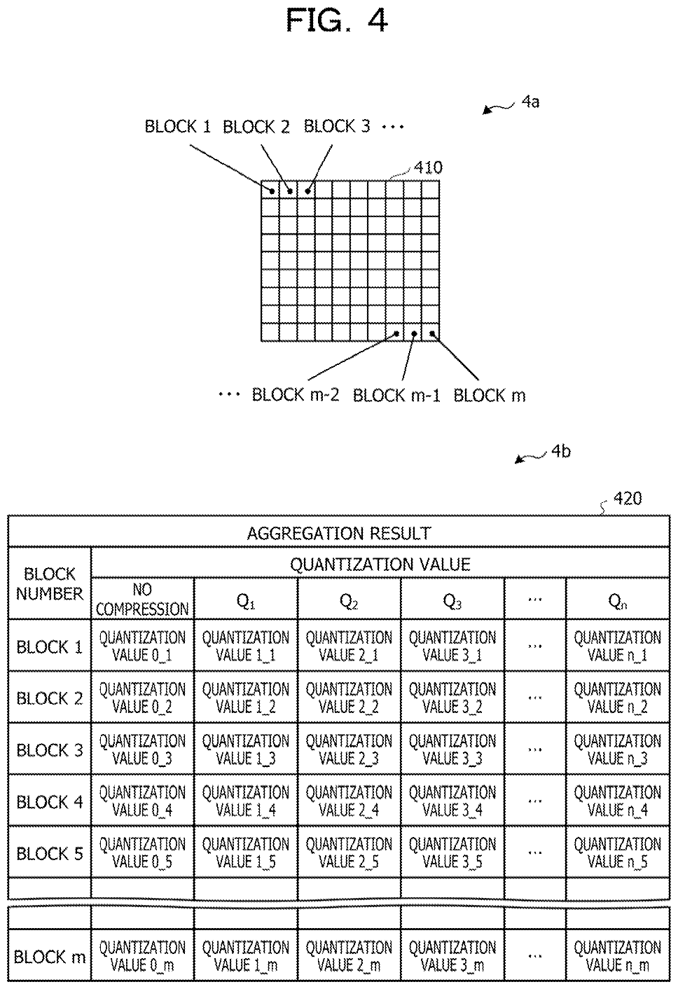

Next, a specific example of the aggregation result stored in the aggregation result storage unit 390 will be described. FIG. 4 is a diagram illustrating a specific example of the aggregation result. In this, an example of the arrangement of respective blocks in image data 410 is indicated by 4a. As indicated by 4a, in the present embodiment, for the sake of brevity of description, it is assumed that the respective blocks in the image data 410 all have the same dimensions and the same shape. In addition, the block number of the upper left block of the image data is assumed as “block 1”, and the block number of the lower right block is assumed as “block m”.

As indicated by 4b, an aggregation result 420 includes “block number” and “quantization value” as information items.

In “block number”, the block number of each block in the image data 410 is stored. In “quantization value”, “no compression” indicating a case where the image compression device 130 does not perform the compression process, and respective quantization values sequentially set in each block by the quantization value setting unit 330, from the minimum quantization value (“Q₁”) to the maximum quantization value (“Qₙ”), are stored.

In addition, the area specified by “block number” and “quantization value” stores an aggregated value aggregated in the corresponding block in such a manner that
the compression process is performed on the image data 410, using the corresponding quantization value, and
the learned model performs the recognition process by inputting the decoded data obtained by decoding the acquired compressed data,
based on the important feature map calculated at the time of recognition process.

<Specific Example of Processing by Quantization Value Designation Unit>

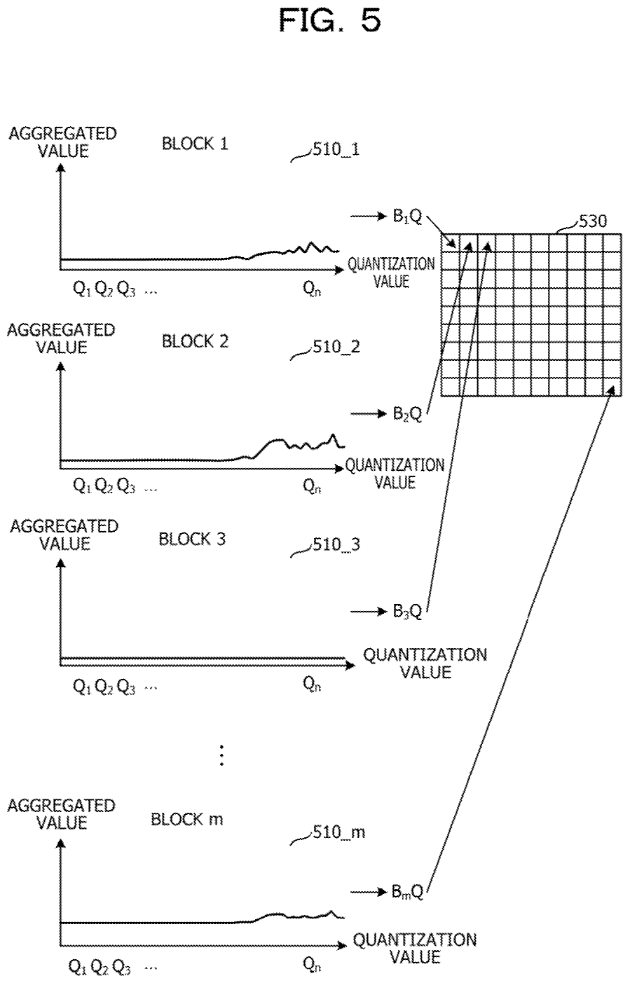

Next, a specific example of processing by the quantization value designation unit 370 will be described. FIG. 5 is a diagram illustrating a specific example of processing by the quantization value designation unit. In FIG. 5, aggregated value graphs 510_1 to 510_m are generated by plotting each of the aggregated values of respective quantization values for each block included in the aggregation result 420, with the quantization value on the horizontal axis and the aggregated value on the vertical axis.

Note that the aggregated values of respective quantization values of each block used to generate the aggregated value graphs 510_1 to 510_m
may be adjusted, for example, using an offset value common to all the blocks,
may be aggregated by taking absolute values, or
the aggregated values of other blocks may be modified based on the aggregated values of the blocks that are not focused.

As illustrated in the aggregated value graphs 510_1 to 510_m, the change in the aggregated value when changed from the minimum quantization value (Q₁) to the maximum quantization value (Qₙ) differs from block to block. The quantization value designation unit 370 designates the optimum quantization value of each block and generates the quantization value map, for example,

when any of the following conditions is satisfied:
when the magnitude of the aggregated value exceeds a predetermined threshold value, or
when the amount of change in the aggregated value exceeds a predetermined threshold value, or
when the slope of the aggregated value exceeds a predetermined threshold value, or
when the change in the slope of the aggregated value exceeds a predetermined threshold value.

In FIG. 5, a quantization value map 530 indicates how B₁Q to BₘQ are designated as the optimum quantization values for the blocks 1 to m and are set in the corresponding blocks in a one-to-one manner.

Note that the size of the block used at the time of aggregation and the size of the block used for the compression process do not have to match. In that case, for example, the quantization value designation unit 370 designates the quantization value as follows.
When the size of the block used for the compression process is larger than the size of the block at the time of aggregation

The average value (alternatively, the minimum value, the maximum value, or a value modified with another index) of the quantization values based on the aggregated value of each block at the time of aggregation contained in the block used for the compression process is adopted as the quantization value of each block used for the compression process.
When the size of the block used for the compression process is smaller than the size of the block at the time of aggregation

The quantization value based on the aggregated value of the block at the time of aggregation is used as the quantization value of each block used for the compression process contained in the block at the time of aggregation.

Note that the process of actually calculating the aggregated value may be performed based only on one quantization value (one compression level). In that case, it is assumed that the aggregated value is calculated by supposing different quantization values (different compression levels) and measuring the difference or change between the aggregated value corresponding to the supposed quantization value and the aggregated value corresponding to the actual quantization value.

At this time, the image quality of the decoded data relevant to the supposed quantization values (different compression levels) may be better or worse than the image quality of the decoded data relevant to the actual quantization value (compression level). However, it is desirable that the supposed quantization values (different compression levels) are a quantization value that makes it easy to estimate the state of the aggregated value. For example, when the aggregated value corresponding to the actual quantization value and the image data that has not undergone the compression process are compared, usually, the aggregated value of the image data that has not undergone the compression process is smaller than the aggregated value corresponding to the actual quantization value.

Note that the aggregated value corresponding to the actual quantization value may be calculated using the decoded data obtained by decoding the compressed data that has undergone the compression process using the actual quantization value. Alternatively, the calculation may be performed using image data that has been subjected to image processing (such as a low-pass filter process as an example) that produces an equal effect.

In addition, the aggregated value corresponding to the actual quantization value may be calculated using image data that has been manipulated beyond the range of image quality change controllable within the range of the maximum and minimum values of the quantization value. For example, the calculation may be performed using image data that has been subjected to image processing exceeding the maximum value of the quantization value that can be employed in a moving image coding process.

In addition, the threshold value applied when the aggregated value graph is evaluated may be different or the same for each block. In addition, the threshold value applied when the aggregated value graph is evaluated may be adjusted or may not be adjusted based on the score information in the recognition result, for example.

In addition, the threshold value applied when the aggregated value graph is evaluated may be automatically designated. For example, the designation may be automatically made according to information that can be acquired at the time of recognition process, information that can be acquired from image data, a value obtained by statistically processing these pieces of information, the data amount of the compressed data and the transition of the data amount, or information that can be acquired based on other processing.

<Specific Example of Processing by Foreground Determination Unit>

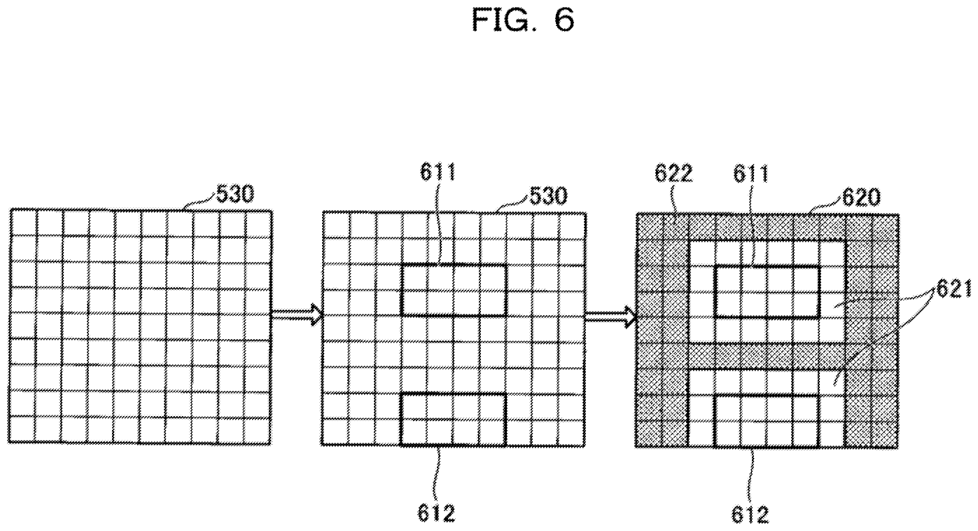

Next, a specific example of processing by the foreground determination unit 380 will be described. FIG. 6 is a diagram illustrating a specific example of processing by the foreground determination unit. As described above, the foreground determination unit 380 is notified by the quantization value designation unit 370 of the quantization value map 530 in which the quantization value is set in each block. In addition, the foreground determination unit 380 is notified by the CNN unit 320 of the bounding box (bounding boxes 611 and 612 in the example in FIG. 6) indicating the area of the object.

For example, the foreground determination unit 380 determines a block contained in the bounding box 611 to be a foreground block. In addition, the foreground determination unit 380 determines whether or not a block on an outer periphery of the bounding box 611 is a foreground block, based on the aggregated value graph.

Similarly, for example, the foreground determination unit 380 determines a block contained in the bounding box 612 to be a foreground block. In addition, the foreground determination unit 380 determines whether or not a block on an outer periphery of the bounding box 612 is a foreground block, based on the aggregated value graph.

Note that, as described above, the method for the foreground determination unit 380 to determine whether or not the foreground block is applicable is not limited to this, and for example, it may be determined whether or not the foreground block is applicable, based only on the aggregated value graph. Alternatively, it may be determined whether or not the foreground block is applicable, based on the class classification probability of each block included in the recognition result notified by the CNN unit 320.

The foreground determination unit 380 does not revise the quantization value set in the block determined to be the foreground block.

On the other hand, the foreground determination unit 380 determines a block other than the foreground block to be a background block. The foreground determination unit 380 generates the designated quantization value map by maximizing the quantization value set in a block determined to be the background block.

In FIG. 6, a designated quantization value map 620 illustrates an example of the designated quantization value map generated by the foreground determination unit 380. The white blocks included in the designated quantization value map 620 are blocks determined to be foreground blocks by the foreground determination unit 380 and are set with the quantization values designated by the quantization value designation unit 370.

On the other hand, the shaded blocks included in the designated quantization value map 620 are blocks determined to be background blocks by the foreground determination unit 380 and are set with maximized quantization values.

<Functional Configuration of Image Compression Device>

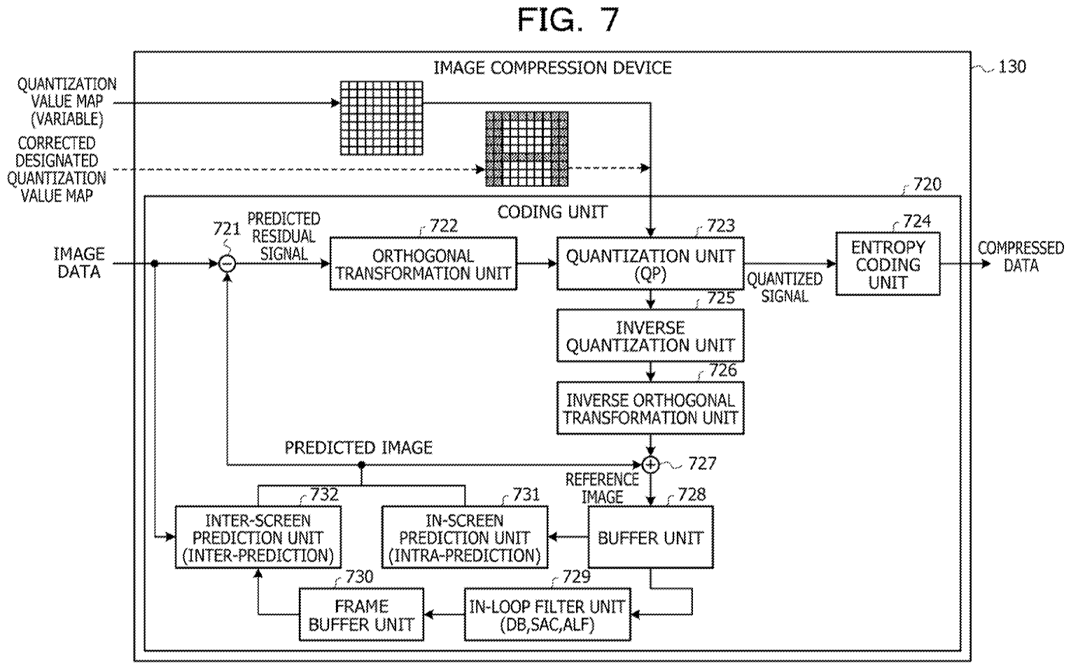

Next, a functional configuration of the image compression device 130 will be described. FIG. 7 is a first diagram illustrating an example of the functional configuration of the image compression device. As described above, the image compression program is installed in the image compression device 130, and when the program is executed, the image compression device 130 functions as a coding unit 720.

The coding unit 720 includes a difference unit 721, an orthogonal transformation unit 722, a quantization unit 723, an entropy coding unit 724, an inverse quantization unit 725, and an inverse orthogonal transformation unit 726. Furthermore, the coding unit 720 includes an addition unit 727, a buffer unit 728, an in-loop filter unit 729, a frame buffer unit 730, an in-screen prediction unit 731, and an inter-screen prediction unit 732.

The difference unit 721 calculates the difference between the image data (for example, the image data 410) and predicted image data and outputs a predicted residual signal.

The orthogonal transformation unit 722 executes an orthogonal transformation process on the predicted residual signal output by the difference unit 721.

The quantization unit 723 quantizes the predicted residual signal that has undergone the orthogonal transformation process and generates a quantized signal. The quantization unit 723 generates the quantized signal using the quantization value map (variable) sequentially transmitted from the analysis device 120 in the first phase and, in the second phase, generates the quantized signal using the corrected designated quantization value map transmitted from the data processing device 140.

The entropy coding unit 724 generates compressed data by performing an entropy coding process on the quantized signal.

The inverse quantization unit 725 inverse-quantizes the quantized signal. The inverse orthogonal transformation unit 726 executes an inverse orthogonal transformation process on the inverse-quantized quantized signal.

The addition unit 727 generates reference image data by adding the signal output from the inverse orthogonal transformation unit 726 and predicted image data. The buffer unit 728 stores the reference image data generated by the addition unit 727.

The in-loop filter unit 729 performs a filter process on the reference image data stored in the buffer unit 728. The in-loop filter unit 729 includes
a deblocking filter (DB),
a sample adaptive offset filter (SAO), and
an adaptive loop filter (ALF).

The frame buffer unit 730 stores the reference image data on which the filter process has been performed by the in-loop filter unit 729, in frame units.

The in-screen prediction unit 731 performs in-screen prediction based on the reference image data and generates the predicted image data. The inter-screen prediction unit 732 performs motion compensation between frames using the input image data (for example, the image data 410) and the reference image data and generates the predicted image data.

The predicted image data generated by the in-screen prediction unit 731 or the inter-screen prediction unit 732 is output to the difference unit 721 and the addition unit 727.

Note that, in the above description, it is assumed that the coding unit 720 performs the compression process using an existing moving image coding scheme such as moving picture experts group (MPEG)-2, MPEG-4, H.264, or high efficiency video coding (HEVC). However, the compression process by the coding unit 720 is not limited to these moving image coding schemes and may be performed using any coding scheme in which the compression rate is controlled by parameters such as quantization values.

<Functional Configuration of Data Processing Device>

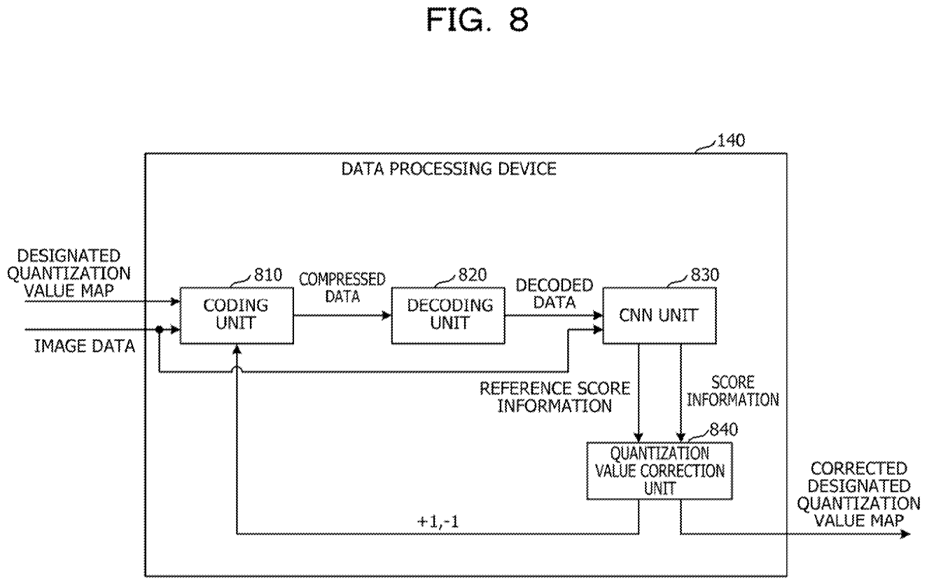

Next, a functional configuration of the data processing device 140 will be described. FIG. 8 is a first diagram illustrating an example of the functional configuration of the data processing device. As described above, the data processing program is installed in the data processing device 140, and when the program is executed, the data processing device 140 functions as a coding unit 810, a decoding unit 820, a CNN unit 830, and a quantization value correction unit 840.

The coding unit 810 performs the compression process on the image data transmitted from the analysis device 120, using the designated quantization value map transmitted from the analysis device 120 and generates the compressed data. In addition, when notified by the quantization value correction unit 840 of an instruction for increasing or decreasing the quantization value of the foreground block of the designated quantization value map, the coding unit 810 performs the compression process on the image data, using the designated quantization value map in which the quantization value has been increased or decreased, and generates the compressed data.

In addition, the coding unit 810 notifies the decoding unit 820 of the generated compressed data each time the compressed data is generated, based on the instruction from the quantization value correction unit 840.

Note that, since the function of the coding unit 810 is basically the same as the function of the coding unit 720 of the image compression device 130, detailed description thereof will be omitted here.

When notified by the coding unit 810 of the compressed data, the decoding unit 820 decodes each piece of the compressed data and generates the decoded data. In addition, the decoding unit 820 notifies the CNN unit 830 of the decoded data.

The CNN unit 830 includes a learned model and, by inputting the decoded data, performs the recognition process on an object that is a recognition target and included in the decoded data, to output the recognition result. In addition, the CNN unit 830 notifies the quantization value correction unit 840 of the score information included in the output recognition result.

Note that the CNN unit 830 performs the recognition process and notifies the quantization value correction unit 840 of the score information each time a notification of the decoded data is given by the decoding unit 820.

At this time, the CNN unit 830 notifies the quantization value correction unit 840 of the score information included in the recognition result output by performing the recognition process
when the coding unit 810 generates the compressed data by performing the compression process using the designated quantization value map, and
when the decoding unit 820 inputs the decoded data generated by decoding the compressed data to the CNN unit 830,

as “reference score information”.

On the other hand, the CNN unit 830 notifies the quantization value correction unit 840 of the score information included in the recognition result output by performing the recognition process
when the coding unit 810 generates the compressed data by performing the compression process using the designated quantization value map in which the quantization value of the foreground block has been increased or decreased, and
when the decoding unit 820 inputs the decoded data generated by decoding the compressed data to the CNN unit 830,

as “score information”.

The quantization value correction unit 840 is an example of a correction unit and, among the quantization values set in each block of the designated quantization value map notified by the analysis device 120, increases or decreases the quantization value set in the foreground block on a predetermined increment basis.

Note that the quantization value correction unit 840 starts the process of increasing the quantization value set in the foreground block on a predetermined increment basis when the reference score information notified by the CNN unit 830 is equal to or higher than a predetermined threshold value (when a predetermined first condition is satisfied).

When the process of increasing the quantization value is started, the quantization value correction unit 840 continues the process of increasing the quantization value while the score information notified by the CNN unit 830 falls within the permissible range defined with respect to the reference score information (while a predetermined second condition is satisfied).

Alternatively, the quantization value correction unit 840 continues the process of increasing the quantization value while the score information notified by the CNN unit 830 is equal to or higher than a predetermined threshold value (while the predetermined first condition is satisfied).

On the other hand, the quantization value correction unit 840 starts the process of decreasing the quantization value set in the foreground block on a predetermined increment basis when the reference score information notified by the CNN unit 830 is lower than the predetermined threshold value (when the predetermined first condition is not satisfied).

When the process of decreasing the quantization value is started, the quantization value correction unit 840 continues the process of decreasing the quantization value while the score information notified by the CNN unit 830 is lower than the predetermined threshold value (while the predetermined first condition is not satisfied).

In addition, when the process of increasing the quantization value or the process of decreasing the quantization value is completed, the quantization value correction unit 840 corrects the quantization value of the foreground block to the quantization value at the time point of completion and transmits the corrected designated quantization value map to the image compression device 130.

Note that, in the above description, the increment basis when the quantization value correction unit 840 increases or decreases the quantization value is assumed as “1” (or “−1”). However, the increment basis when the quantization value is increased or decreased by the quantization value correction unit 840 may be “1” (or “−1”), or may be “1” or higher (or “−1” or lower).

In addition, in the above description, in determining whether or not the quantization value correction unit 840 continues the process of increasing the quantization value, the permissible range defined based on the reference score information has been described as being compared with the score information.

However, the method for determining whether or not to continue the process of increasing the quantization value is not limited to this. For example, the intersection over union (IoU) calculated based on the bounding box included in the recognition result output from the CNN unit 830 may be compared with a predefined permissible range of the IoU.

Note that the process of increasing the quantization value by the quantization value correction unit 840 may be made controllable regarding to what extent the process is strictly performed, according to the applied usage purpose, the demanded recognition accuracy, and the like.

<Specific Example of Processing by Data Processing Device>

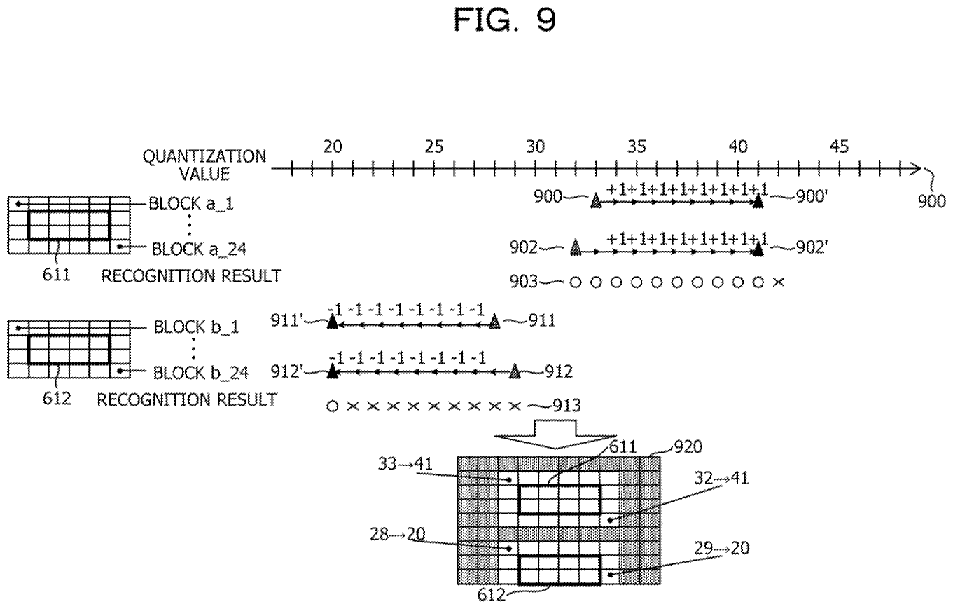

Next, a specific example of processing by the data processing device 140 will be described. FIG. 9 is a diagram illustrating a specific example of processing by the data processing device. In FIG. 9, a horizontal axis 900 indicates the quantization value.

In addition, in FIG. 9, the reference sign 901 indicates a quantization value set in a block a_1 in the designated quantization value map, among 24 blocks (blocks a_1 to a_24) included in the foreground blocks.

Similarly, in FIG. 9, the reference sign 902 indicates a quantization value set in a block a_24 in the designated quantization value map, among the 24 blocks (the blocks a_1 to a_24) included in the foreground blocks.

According to the example in FIG. 9, the quantization value set in the block a_1 is “33”, and the quantization value set in the block a_24 is “32”. In addition, according to the example of the reference sign 903 in FIG. 9, it is indicated that the reference score information when the compression process is performed using these quantization values and the recognition process is performed on the decoded data obtained by decoding the compressed data is determined to be equal to or higher than the predetermined threshold value (to satisfy the predetermined first condition).

Furthermore, the example in FIG. 9 indicates that, as a result of the quantization value correction unit 840 increasing the quantization value on the increment basis=“1” at a time, the score information is determined not to satisfy the predetermined first or second condition when the quantization value is “42” (refer to the right end of the reference sign 903).

Therefore, in the example in FIG. 9, the quantization value correction unit 840 corrects the quantization value of the block a_1 from “33” to “41” and the quantization value of the block a_24 from “32” to “41”, as indicated in a corrected designated quantization value map 920.

Similarly, in FIG. 9, the reference sign 911 indicates a quantization value set in a block b_1 in the designated quantization value map, among 24 blocks (blocks b_1 to b_24) included in the foreground blocks.

Similarly, in FIG. 9, the reference sign 912 indicates a quantization value set in a block b_24 in the designated quantization value map, among the 24 blocks (the blocks b_1 to b_24) included in the foreground blocks.

According to the example in FIG. 9, the quantization value set in the block b_1 is “28”, and the quantization value set in the block b_24 is “29”. In addition, according to the example of the reference sign 913 in FIG. 9, it is indicated that the reference score information when the compression process is performed using these quantization values and the recognition process is performed on the decoded data obtained by decoding the compressed data is determined to be lower than the predetermined threshold value (not to satisfy the predetermined first condition).

Furthermore, the example in FIG. 9 indicates that, as a result of the quantization value correction unit 840 decreasing the quantization value on the increment basis=“1” at a time, the score information is determined to satisfy the predetermined first condition when the quantization value is “20” (refer to the left end of the reference sign 913).

Therefore, in the example in FIG. 9, the quantization value correction unit 840 corrects the quantization value of the block b_1 from “28 to “20” and the quantization value of the block b_24 from “29” to “20”, as indicated in the corrected designated quantization value map 920.

Note that, in the example in FIG. 9, a case where the quantization value of each block is uniformly increased has been described, but the method of increasing the quantization value of each block is not limited to this. For example, a process of specifying the minimum quantization value among the quantization values of the respective blocks and increasing only the quantization value of the block of the specified minimum quantization value may be sequentially carried out.

For example, it is assumed that the quantization value of the block a_10 is “30”, the quantization value of the block a_11 is “32”, and the quantization value of the block a_12 is “36”. In this case, in the example in FIG. 9, increases will be made as (31, 33, 37), (32, 34, 38), . . . , but according to the above increasing method, increases will be made as (31, 32, 36), (32, 32, 36), (33, 33, 36), . . . .

In addition, the reference score information may be defined for each object, and the quantization value may be corrected based on the recognition result of each object.

For example, when the quantization value of each block is uniformly increased and the recognition process is performed on an object A and an object B,

it is assumed that
the object A is recognizable when the quantization value of a block contained in the object A is “40”, but the object A is not recognizable when the quantization value is “41” or higher, and
the object B is recognizable when the quantization value of a block contained in the object B is “30”, but the object B is not recognizable when the quantization value is “31” or higher.

In such a case, the quantization value of the block contained in the object A is corrected to “40”, and the quantization value of the block contained in the object B is corrected to “30”, separately.

However, when the quantization values are corrected individually for each object, the consistency of the entire image data is unlikely to be kept, and an unrecognizable object is likely to occur. In such a case, a correction may be made using the maximum value of the logical product condition of quantization values that allow all the objects to be recognizable.

Alternatively, the quantization value of the block contained in the object B may be fixed at a quantization value at the time point when a search end condition is satisfied, and the quantization value of the block contained in the object A may be continuously increased until the search end condition is satisfied.

<Flow of Image Compression Process by Compression Processing System>

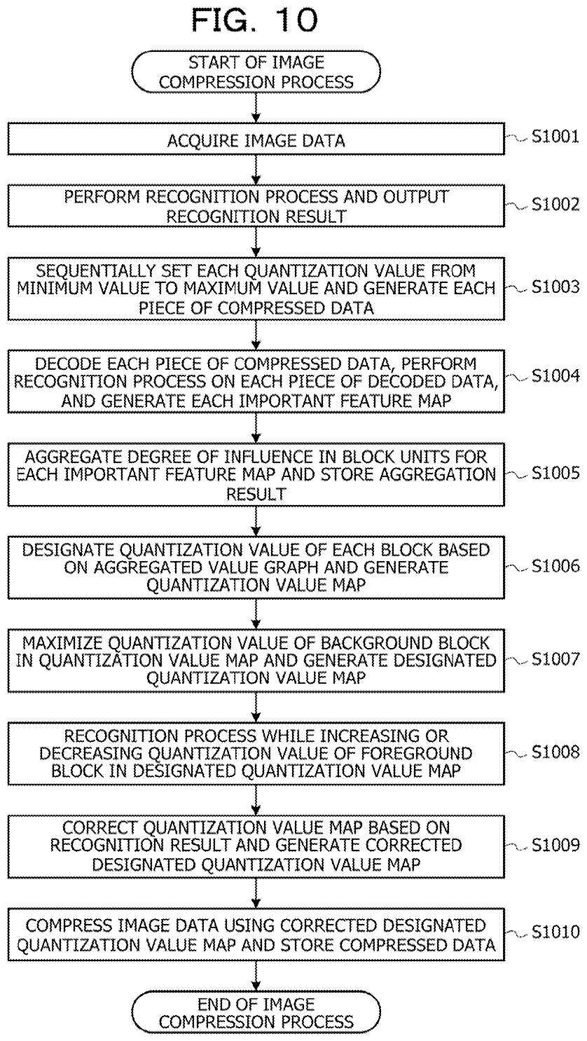

Next, a flow of an image compression process by the compression processing system 100 will be described. FIG. 10 is a first flowchart illustrating an example of the flow of the image compression process by the compression processing system.

In step S1001, the input unit 310 of the analysis device 120 acquires image data, and in step S1002, the CNN unit 320 of the analysis device 120 performs the recognition process on the acquired image data and outputs a recognition result.

In step S1003, the quantization value setting unit 330 of the analysis device 120 sequentially sets each quantization value from the minimum quantization value (Q₁) to the maximum quantization value (Qₙ), and the output unit 340 transmits each quantization value map (variable) to the image compression device 130. In addition, the image compression device 130 performs the compression process on the image data using each transmitted quantization value map (variable) and generates each piece of compressed data.

In step S1004, the input unit 310 of the analysis device 120 decodes each piece of the compressed data generated by the image compression device 130. In addition, the CNN unit 320 of the analysis device 120 performs the recognition process on each piece of decoded data. Furthermore, the important feature map generation unit 350 of the analysis device 120 generates each important feature map indicating the degree of influence of each area of the decoded data on the recognition result, based on the CNN unit structure information.

In step S1005, the aggregation unit 360 of the analysis device 120 aggregates the degree of influence of each area in block units, for each important feature map. In addition, the aggregation unit 360 of the analysis device 120 stores the aggregation result in the aggregation result storage unit 390 in association with each compression level (quantization value).

In step S1006, the quantization value designation unit 370 of the analysis device 120 designates the quantization value in block units based on the aggregated value graph of each block and generates the quantization value map.

In step S1007, the foreground determination unit 380 of the analysis device 120 maximizes the quantization value set in the background block in the generated quantization value map and generates the designated quantization value map.

In step S1008, the data processing device 140 performs the recognition process while increasing or decreasing the quantization value set in the foreground block, among the quantization values set in the respective blocks of the designated quantization value map.

In step S1009, the data processing device 140 corrects the quantization value set in the foreground block of the designated quantization value map, based on the recognition result and generates the corrected designated quantization value map.

In step S1010, the image compression device 130 performs the compression process on the image data, using the corrected designated quantization value map and stores the compressed data in the storage device 150.

As is clear from the above description, in a case where the designated quantization value map is generated based on the degree of influence of each block on the recognition result when the recognition process is performed on the image data, the data processing device according to the first embodiment performs the compression process using the designated quantization value map.

In addition, in a case where the recognition result when the recognition process is performed on the decoded data obtained by decoding the compressed data satisfies a predetermined condition, the data processing device according to the first embodiment corrects the foreground block corresponding to the recognition target in a direction of raising the compression level (quantization value).

In this manner, the data processing device according to the first embodiment corrects the quantization value designated based on the degree of influence on the recognition result in a direction of raising the quantization value based on the recognition result. Consequently, according to the first embodiment, the compression level may be improved while the recognition accuracy is maintained. For example, according to the first embodiment, a compression process suitable for a recognition process by AI may be implemented.

### Second Embodiment

In the first embodiment described above, a case has been described in which, by correcting the quantization value designated based on the degree of influence on the recognition result, based on the recognition result, the compression level is improved while the recognition accuracy is maintained. However, depending on the image data, there may be image data whose recognition accuracy is already low in a state in which the compression process is not performed.

Thus, in a second embodiment, the recognition accuracy of such image data is improved by first altering the image data itself. Subsequently, the quantization value of the altered image data is designated based on the degree of influence on the recognition result, and the compression process is performed using the quantization value that has been designated.

Consequently, according to the second embodiment, the compression level of the image data may be improved while the recognition accuracy is improved. The second embodiment will be described below focusing on differences from the first embodiment described above.

<System Configuration of Compression Processing System>

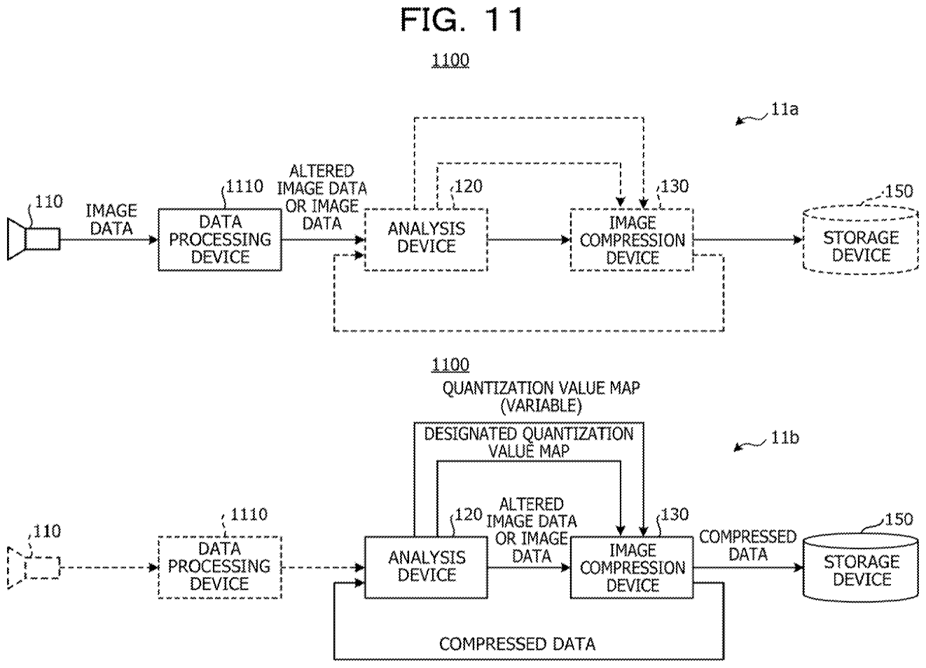

First, a system configuration of the entire compression processing system including a data processing device according to the second embodiment will be described. FIG. 11 is a second diagram illustrating an example of the system configuration of the compression processing system. In the second embodiment, the processing executed by a compression processing system 1100 can be roughly divided into:
a first phase of altering image data; and
a second phase of storing compressed data by generating a designated quantization value map based on the altered image data and performing a compression process using the generated designated quantization value map.

In FIG. 11, a system configuration of the compression processing system 1100 in the first phase is indicated by 11a, and a system configuration of the compression processing system 1100 in the second phase is indicated by 11b.

As illustrated in 11a of FIG. 11, the compression processing system 1100 in the first phase includes an imaging device 110 and a data processing device 1110. Among these, since the processing by the imaging device 110 is similar to the processing by the imaging device 110 described with reference to la of FIG. 1 in the above first embodiment, the description thereof will be omitted here.

The data processing device 1110 performs a recognition process on image data transmitted from the imaging device 110. In addition, the data processing device 1110 determines whether or not the score information included in the recognition result satisfies a predetermined condition and, when it is determined that the score information does not satisfy the predetermined condition, alters the image data such that the score information is maximized, to transmit the altered image data to an analysis device 120.

Note that, when it is determined that the score information included in the recognition result satisfies the predetermined condition, the data processing device 1110 transmits the image data to the analysis device 120 without altering the image data.

Meanwhile, as illustrated in 11b of FIG. 11, the compression processing system 1100 in the second phase includes the analysis device 120, an image compression device 130, and a storage device 150.

The analysis device 120 includes a learned model that performs a recognition process. The analysis device 120 performs the recognition process by inputting image data or altered image data to the learned model and outputs a recognition result. In addition, the analysis device 120 acquires each piece of compressed data output by the image compression device 130 performing a compression process on the image data or the altered image data at different compression levels (quantization values), and generates each piece of decoded data by decoding each piece of the compressed data. Furthermore, the analysis device 120 performs the recognition process by inputting each piece of the decoded data to the learned model and outputs a recognition result.

In addition, the analysis device 120 generates an important feature map by performing motion analysis for the learned model at the time of the recognition process, using, for example, an error back propagation method. Furthermore, the analysis device 120 aggregates the degree of influence for each block based on the important feature map.

Note that, by sequentially transmitting a quantization value map (variable) in which the quantization value is set in each block to the image compression device 130, the analysis device 120 instructs the image compression device 130 to perform the compression process at different compression levels (quantization values).

In addition, the analysis device 120 generates an aggregated value graph for each block, based on the aggregated value of the degree of influence of each block calculated each time the recognition process is performed on each piece of the decoded data. In addition, the analysis device 120 designates an optimum compression level (quantization value) of each block, based on each of the aggregated value graphs for each block and generates the designated quantization value map.

The image compression device 130 performs the compression process on the image data or the altered image data, using the generated designated quantization value map and stores the compressed data in the storage device 150.

<Functional Configuration of Data Processing Device>

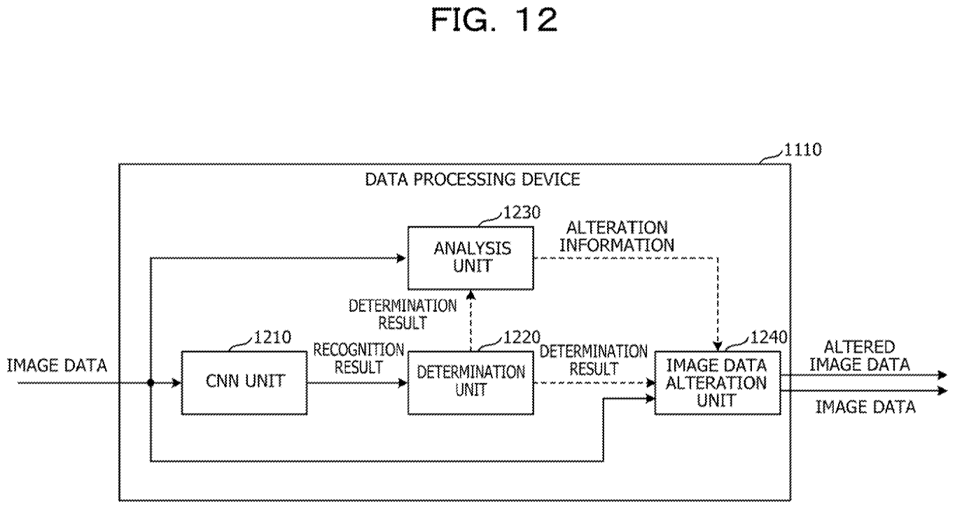

Next, a functional configuration of the data processing device 1110 will be described. FIG. 12 is a second diagram illustrating an example of the functional configuration of the data processing device. Similar to the first embodiment described above, the data processing program is installed in the data processing device 1110, and when the program is executed, the data processing device 1110 functions as a CNN unit 1210 and a determination unit 1220. In addition, the data processing device 1110 functions as an analysis unit 1230 and an image data alteration unit 1240.

The CNN unit 1210 includes a learned model and, by inputting the image data, performs the recognition process on an object that is a recognition target and included in the image data, to output the recognition result.

The determination unit 1220 determines whether or not the score information (an example of information that relates to the recognition accuracy of image data) included in the recognition result output from the CNN unit 1210 satisfies a predetermined condition (for example, determines whether or not the score information is equal to or higher than a predetermined threshold value).

When it is determined that the score information included in the recognition result satisfies the predetermined condition, the determination unit 1220 notifies the image data alteration unit 1240 of the determination result. On the other hand, when it is determined that the score information included in the recognition result does not satisfy the predetermined condition, the determination unit 1220 notifies the analysis unit 1230 of the determination result.

When notified of the determination result by the determination unit 1220, the analysis unit 1230 acquires the image data and analyzes the acquired image data. In addition, the analysis unit 1230 notifies the image data alteration unit 1240 of alteration information for maximizing the score information, which has been generated by analyzing the image data. Alternatively, the analysis unit 1230 notifies the image data alteration unit 1240 of image data (altered image data) for maximizing the score information, which has been generated by analyzing the image data.

The image data alteration unit 1240 is an example of an alteration unit. When notified of the determination result by the determination unit 1220, the image data alteration unit 1240 transmits the image data to the analysis device 120 without altering the image data.

In addition, when notified of the alteration information by the analysis unit 1230, the image data alteration unit 1240 alters the image data based on the notified alteration information and transmits the altered image data to the analysis device 120. Alternatively, when notified of the altered image data by the analysis unit 1230, the image data alteration unit 1240 transmits the altered image data to the analysis device 120.

<Specific Example of Processing of Analysis Unit (1)>

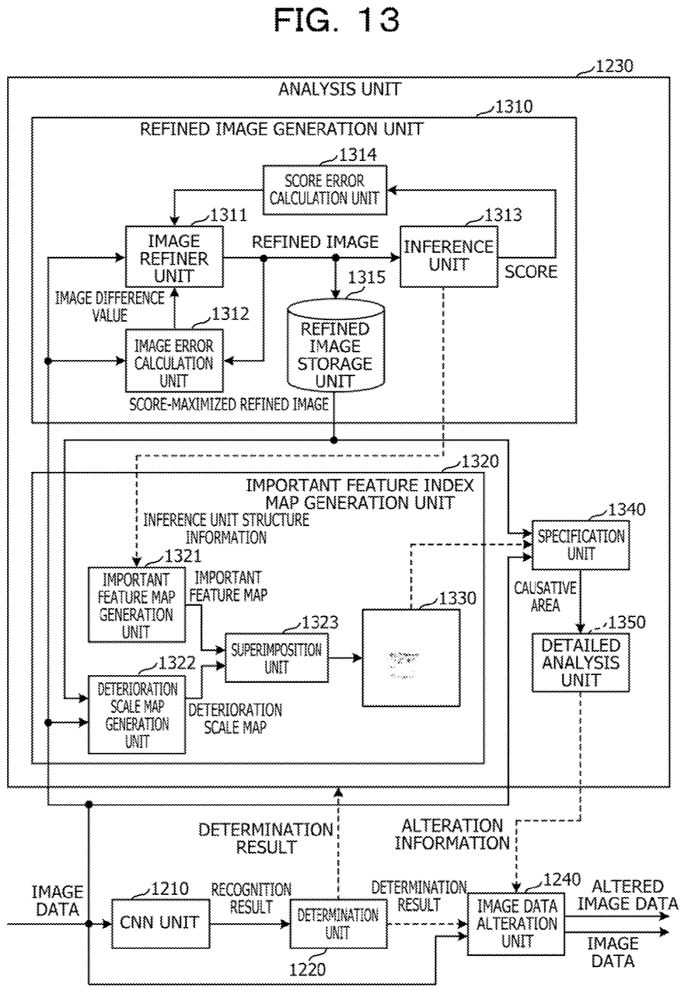

Next, a specific example of processing by the analysis unit 1230 of the data processing device 1110 will be described. FIG. 13 is a first diagram illustrating a specific example of processing by the analysis unit. As illustrated in FIG. 13, the analysis unit 1230 includes, for example, a refined image generation unit 1310, an important feature index map generation unit 1320, a specification unit 1340, and a detailed analysis unit 1350.

In addition, the refined image generation unit 1310 includes an image refiner unit 1311, an image error calculation unit 1312, an inference unit 1313, and a score error calculation unit 1314.

The image refiner unit 1311 generates refined image data from the image data, for example, by performing learning using a CNN as an image data generation model.

Note that the image refiner unit 1311 alters the image data such that the score information of the correct answer label is maximized when the inference unit 1313 performs the recognition process using the generated refined image data. In addition, the image refiner unit 1311 generates the refined image data such that an amount of alteration from the image data (a difference between the refined image data and the image data) becomes smaller, for example. Consequently, according to the image refiner unit 1311, refined image data that is visually close to the image data before the alteration may be obtained.

For example, the image refiner unit 1311 performs CNN learning so as to minimize
an error (score error) between the score information when the recognition process is performed using the generated refined image data and the score information obtained by maximizing the score information of the correct answer label, and
an image difference value, which is the difference between the generated refined image data and the image data.

The image error calculation unit 1312 calculates the difference between the image data and the refined image data output from the image refiner unit 1311 during CNN learning, and inputs the image difference value to the image refiner unit 1311. The image error calculation unit 1312 calculates the image difference value by performing, for example, a difference (L1 difference) or structural similarity (SSIM) calculation for each pixel, and inputs the calculated image difference value to the image refiner unit 1311.

The inference unit 1313 includes a learned CNN that performs the recognition process using the refined image data generated by the image refiner unit 1311 as an input and outputs the score information. Note that the score error calculation unit 1314 is notified of the score information output by the inference unit 1313.

The score error calculation unit 1314 calculates the error between the score information notified by the inference unit 1313 and the score information obtained by maximizing the score information of the correct answer label, and notifies the image refiner unit 1311 of the score error. The score error notified by the score error calculation unit 1314 is used for CNN learning in the image refiner unit 1311.

Note that a refined image output from the image refiner unit 1311 during learning of the CNN included in the image refiner unit 1311 is stored in a refined image storage unit 1315. The learning of the CNN included in the image refiner unit 1311 is performed
by a preassigned number of times of learning (for example, the maximum number of times of learning=N times), or
until the score information of the correct answer label exceeds a predetermined threshold value, or
until the score information of the correct answer label exceeds a predetermined threshold value and the image difference value becomes smaller than a predetermined threshold value.

Hereinafter, the refined image data when the score information of the correct answer label output by the inference unit 1313 is maximized will be referred to as “score-maximized refined image data”.

Subsequently, details of the important feature index map generation unit 1320 will be described. As illustrated in FIG. 13, the important feature index map generation unit 1320 includes an important feature map generation unit 1321, a deterioration scale map generation unit 1322, and a superimposition unit 1323.

The important feature map generation unit 1321 acquires, from the inference unit 1313, inference unit structure information when the inference unit 1313 performed the recognition process using the score-maximized refined image data as an input. In addition, the important feature map generation unit 1321 generates the important feature map based on the inference unit structure information by using the BP method, the GBP method, or the selective BP method.

The deterioration scale map generation unit 1322 generates a “deterioration scale map” based on the image data and the score-maximized refined image data. The deterioration scale map is a map illustrating altered parts and the degree of alteration of each altered part when the image data is altered to the score-maximized refined image data.

The superimposition unit 1323 generates an important feature index map 1330 by superimposing the important feature map generated by the important feature map generation unit 1321 and the deterioration scale map generated by the deterioration scale map generation unit 1322. The important feature index map 1330 is a map that visualizes the degree of influence of each area of the image data on the recognition result.

The specification unit 1340 divides the image data, for example, in super pixel units and aggregates the important feature index map 1330 in super pixel units. In addition, the specification unit 1340 specifies a super pixel whose image data is to be altered, based on the aggregation result. Furthermore, the specification unit 1340 notifies the detailed analysis unit 1350 of the important feature index map 1330 included in the specified super pixel out of the important feature index map 1330, as a causative area of erroneous recognition.

The detailed analysis unit 1350 generates the alteration information for altering the image data, in pixel units, based on the causative area generated by the specification unit 1340 and notifies the image data alteration unit 1240 of the generated alteration information.

This causes the image data alteration unit 1240 to alter the image data in pixel units, based on the alteration information and to transmit the altered image data to the analysis device 120.

<Specific Example of Processing of Analysis Unit (2)>

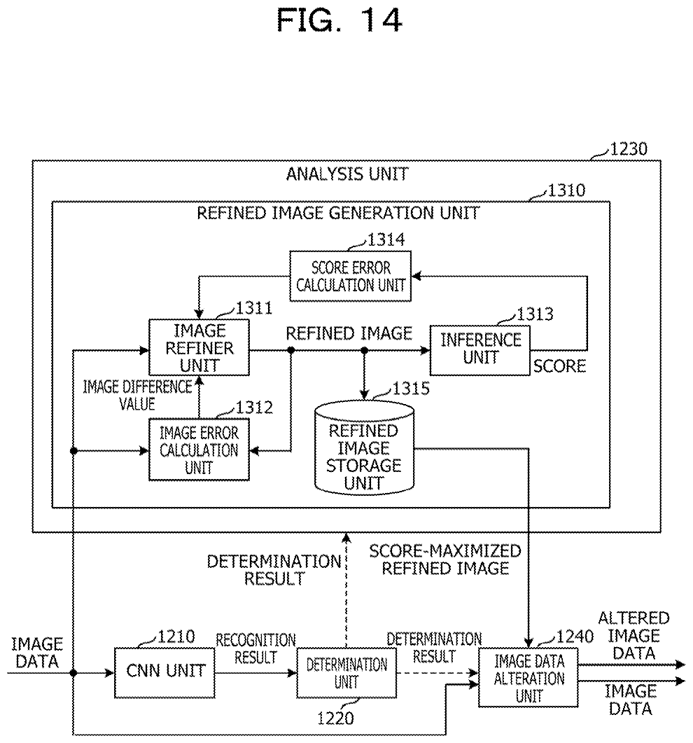

Next, another specific example of processing by the analysis unit 1230 of the data processing device 1110 will be described. FIG. 14 is a second diagram illustrating a specific example of processing by the analysis unit. As illustrated in FIG. 14, the analysis unit 1230 includes, for example, the refined image generation unit 1310.

The refined image generation unit 1310 includes the image refiner unit 1311, the image error calculation unit 1312, the inference unit 1313, and the score error calculation unit 1314. Note that the function of each unit included in the refined image generation unit 1310 is the same as the function of each unit included in the refined image generation unit 1310 illustrated in FIG. 13. However, in the case of FIG. 14, a score-maximized refined image stored in the refined image storage unit 1315 is read by the image data alteration unit 1240 as altered image data.

This causes the image data alteration unit 1240 to transmit the score-maximized refined image read from the refined image storage unit 1315 to the analysis device 120 as altered image data.

<Flow of Image Compression Process by Compression Processing System>

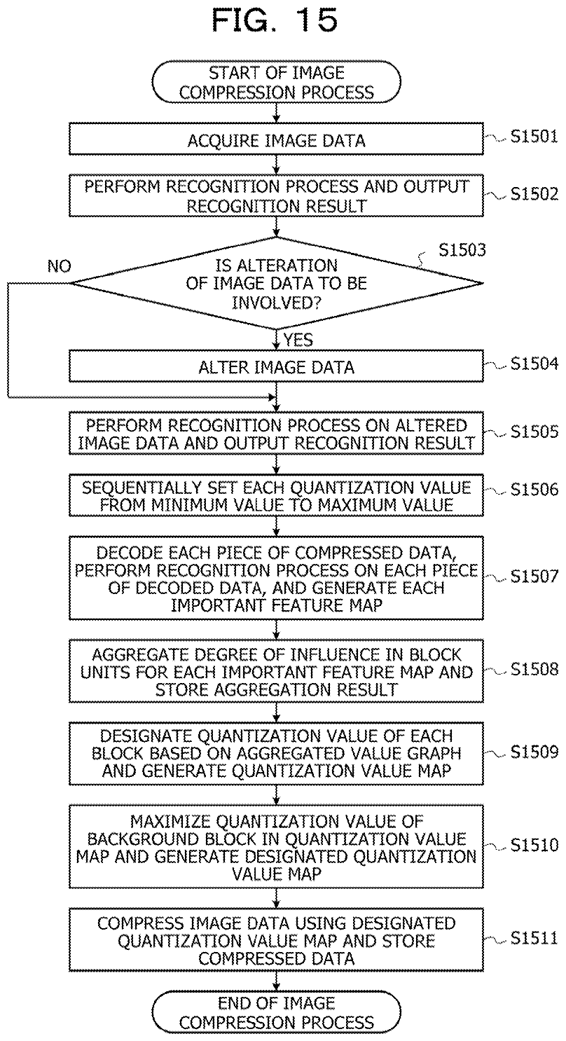

Next, a flow of an image compression process by the compression processing system 1100 will be described. FIG. 15 is a second flowchart illustrating an example of the flow of the image compression process by the compression processing system.

In step S1501, the CNN unit 1210 of the data processing device 1110 acquires image data from the imaging device 110.

In step S1502, the CNN unit 1210 of the data processing device 1110 performs the recognition process on the acquired image data and outputs the recognition result.

In step S1503, the determination unit 1220 of the data processing device 1110 determines whether or not the alteration of the image data is to be involved, by determining whether or not the score information included in the recognition result satisfies a predetermined condition. When it is determined in step S1503 that the predetermined condition is not satisfied (in the case of Yes in step S1503), it is determined that the alteration of the image data is to be involved, and the process proceeds to step S1504.

In step S1504, the analysis unit 1230 of the data processing device 1110 generates the alteration information for altering the image data such that the score information is maximized. In addition, the image data alteration unit 1240 of the data processing device 1110 alters the image data based on the generated alteration information and transmits the altered image data to the analysis device 120.

Alternatively, the analysis unit 1230 of the data processing device 1110 generates the score-maximized refined image by altering the image data such that the score information is maximized, and notifies the image data alteration unit 1240 of the generated score-maximized refined image. In addition, the image data alteration unit 1240 of the data processing device 1110 transmits the score-maximized refined image to the analysis device 120 as altered image data.

On the other hand, when it is determined in step S1503 that the predetermined condition is satisfied (in the case of No in step S1503), it is determined that the alteration of the image data is not to be involved, and the image data is transmitted to the analysis device 120 without being altered.

In step S1505, a CNN unit 320 of the analysis device 120 performs the recognition process on the altered image data (or the image data) transmitted from the image data alteration unit 1240 and outputs the recognition result.

In step S1506, a quantization value setting unit 330 of the analysis device 120 sequentially sets each quantization value from the minimum quantization value (Q₁) to the maximum quantization value (Qₙ), and an output unit 340 transmits each quantization value map (variable) to the image compression device 130. In addition, the image compression device 130 performs the compression process on the image data using each transmitted quantization value map (variable) and generates each piece of compressed data.

In step S1507, an input unit 310 of the analysis device 120 decodes each piece of the compressed data generated by the image compression device 130. In addition, the CNN unit 320 of the analysis device 120 performs the recognition process on each piece of decoded data. Furthermore, an important feature map generation unit 350 of the analysis device 120 generates each important feature map indicating the degree of influence of each area of the decoded data on the recognition result, based on the CNN unit structure information.

In step S1508, an aggregation unit 360 of the analysis device 120 aggregates the degree of influence of each area in block units, for each important feature map. In addition, the aggregation unit 360 of the analysis device 120 stores the aggregation result in an aggregation result storage unit 390 in association with each compression level (each quantization value).

In step S1509, a quantization value designation unit 370 of the analysis device 120 designates the quantization value in block units based on the aggregated value graph of each block and generates the quantization value map.

In step S1510, a foreground determination unit 380 of the analysis device 120 maximizes the quantization value set in the background block in the generated quantization value map and generates the designated quantization value map.

In step S1511, the image compression device 130 performs the compression process on the altered image data (or the image data) using the designated quantization value map and stores the compressed data in the storage device 150.

As is clear from the above description, the data processing device according to the second embodiment performs the recognition process on the image data acquired from the imaging device 110 and determines whether or not the score information satisfies a predetermined condition. In addition, when it is determined that the predetermined condition is not satisfied, the data processing device according to the second embodiment alters the image data such that the score information is maximized.

By altering the image data itself in this manner, according to the second embodiment, the recognition accuracy may be improved even when image data having low recognition accuracy is acquired.

In addition, according to the second embodiment, since the designated quantization value map is generated based on the altered image data, the designated quantization value map in which a high quantization value is set may be generated.

Consequently, according to the second embodiment, the compression level may be improved while the recognition accuracy is improved. For example, according to the data processing device according to the second embodiment, a compression process suitable for the recognition process by AI may be implemented.

### Third Embodiment

In the second embodiment described above, a case has been described in which, by first altering the image data, the compression level is improved while the recognition accuracy is improved when image data having low recognition accuracy is input.

In contrast to this, in a third embodiment, it is determined whether or not the alteration of the image data is to be involved, in the course of increasing the quantization value when the designated quantization value map is generated, and the image data is altered when it is determined that the alteration of the image data is to be involved.

Consequently, according to the third embodiment, the compression level may be improved while the recognition accuracy is improved, as in the second embodiment. The third embodiment will be described below focusing on differences from the second embodiment described above.

<System Configuration of Compression Processing System>

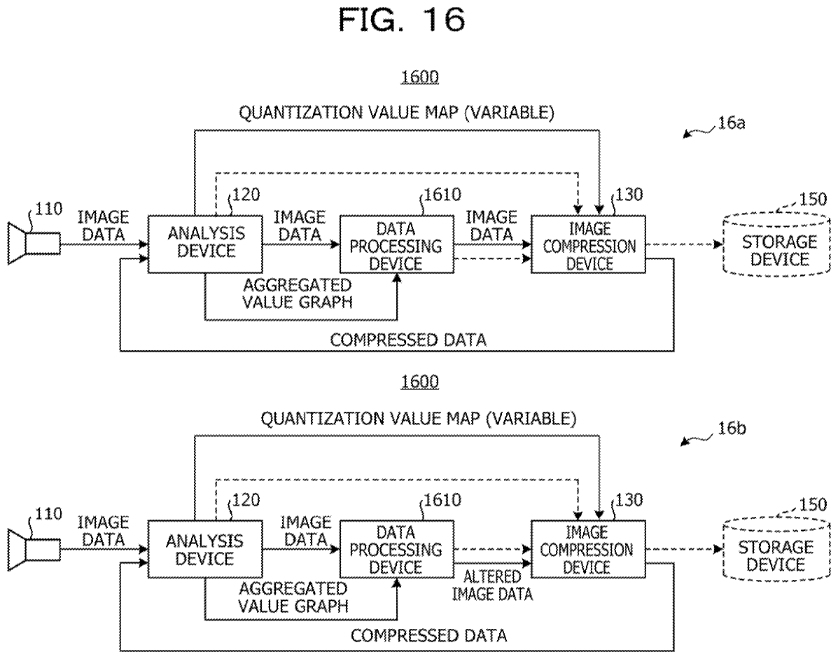

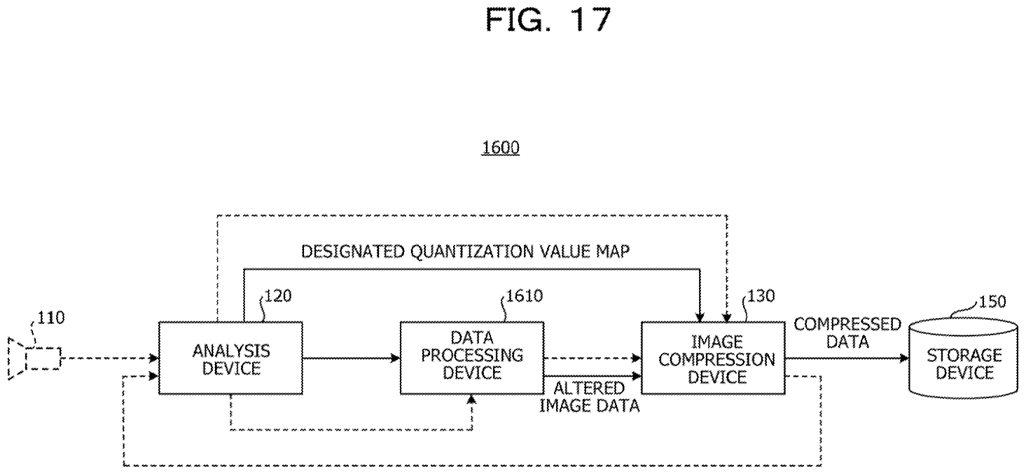

First, a system configuration of the entire compression processing system including a data processing device according to the third embodiment will be described. FIGS. 16 and 17 are third and fourth diagrams illustrating an example of the system configuration of the compression processing system. In the third embodiment, the processing executed by the compression processing system can be roughly divided into:
a first phase of performing a compression process at different compression levels (quantization values) in order to generate the designated quantization value map and additionally monitoring the aggregated value graph;
a second phase of altering the image data and performing a similar process on the altered image data when it is determined that the alteration of the image data is to be involved, based on the aggregated value graph; and
a third phase of storing the compressed data by generating the designated quantization value map and performing a compression process on the altered image data, using the generated designated quantization value map.

In FIG. 16, a system configuration of a compression processing system 1600 in the first phase is indicated by 16a, and a system configuration of the compression processing system 1600 in the second phase is indicated by 16b. In addition, FIG. 17 illustrates a system configuration of the compression processing system 1600 in the third phase.

As illustrated in 16a of FIG. 16, the compression processing system 1600 in the first phase includes an imaging device 110, an analysis device 120, a data processing device 1610, and an image compression device 130. Among these, since the processing by the imaging device 110 and the image compression device 130 is similar to the processing by the imaging device 110 and the image compression device 130 described with reference to 11a or 11b of FIG. 11 in the above second embodiment, the description thereof will be omitted here.

The analysis device 120 includes a learned model that performs a recognition process. The analysis device 120 performs the recognition process by inputting image data to the learned model and outputs a recognition result. In addition, the analysis device 120 acquires each piece of compressed data output by the image compression device 130 performing a compression process on the image data at different compression levels (quantization values), and generates each piece of decoded data by decoding each piece of the compressed data. Furthermore, the analysis device 120 performs the recognition process by inputting each piece of the decoded data to the learned model and outputs a recognition result.

In addition, the analysis device 120 generates an important feature map by performing motion analysis for the learned model at the time of the recognition process, using, for example, an error back propagation method and aggregates the degree of influence for each block.

Note that, by sequentially transmitting a quantization value map (variable) in which the quantization value is set in each block to the image compression device 130, the analysis device 120 instructs the image compression device 130 to perform the compression process at different compression levels (quantization values).

In addition, the analysis device 120 generates an aggregated value graph for each block, based on the aggregated value of the degree of influence of each block aggregated each time the recognition process is performed on each piece of the decoded data. In addition, the analysis device 120 transmits each of the aggregated value graphs for each block to the data processing device 1610 each time the aggregated value is updated.

The data processing device 1610 monitors the aggregated value graph transmitted from the analysis device 120 for each block and determines whether or not the alteration of the image data is to be involved (for example, when the magnitude of the aggregated value in the aggregated value graph exceeds a predetermined threshold value, it is determined that the alteration of the image data is to be involved). When it is determined that the alteration of the image data is not to be involved, the data processing device 1610 transmits the image data to the image compression device 130 without altering the image data.

Meanwhile, as illustrated in 16b of FIG. 16, the compression processing system 1600 in the second phase includes the imaging device 110, the analysis device 120, the data processing device 1610, and the image compression device 130. Among these, since the processing by the imaging device 110 and the image compression device 130 is similar to the processing by the imaging device 110 and the image compression device 130 described with reference to 11a or 11b of FIG. 11 in the above second embodiment, the description thereof will be omitted here. In addition, since the processing by the analysis device 120 is the same as the processing by the analysis device 120 in the first phase described above, the description thereof will be omitted here.

In the second phase, the data processing device 1610 monitors the aggregated value graph transmitted from the analysis device 120 for each block and determines whether or not the alteration of the image data is to be involved.

In addition, when it is determined that the alteration of the image data is to be involved, the data processing device 1610 alters the image data and transmits the altered image data to the image compression device 130.

Furthermore, as illustrated in FIG. 17, the compression processing system 1600 in the third phase includes the analysis device 120, the data processing device 1610, and the image compression device 130.

The analysis device 120 designates an optimum compression level (quantization value) of each block, based on the generated aggregated value graph and generates the designated quantization value map. In addition, the analysis device 120 transmits the generated designated quantization value map to the image compression device 130.

The data processing device 1610 transmits the altered image data to the image compression device 130.

The image compression device 130 performs the compression process on the altered image data, using the designated quantization value map and stores the compressed data in the storage device 150.

<Functional Configuration of Data Processing Device>

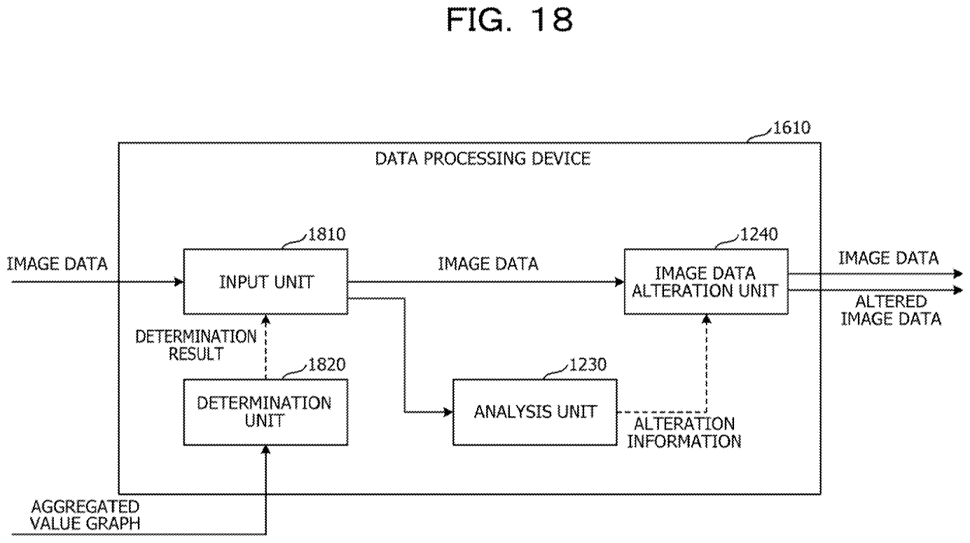

Next, a functional configuration of the data processing device 1610 will be described. FIG. 18 is a third diagram illustrating an example of the functional configuration of the data processing device. Similar to the second embodiment described above, the data processing program is installed in the data processing device 1610, and when the program is executed, the data processing device 1610 functions as an input unit 1810 and a determination unit 1820. In addition, the data processing device 1610 functions as an analysis unit 1230 and an image data alteration unit 1240.

Among these, since the processing of the analysis unit 1230 and the image data alteration unit 1240 is similar to the processing of the analysis unit 1230 and the image data alteration unit 1240 of the data processing device 1110 in FIG. 12, the description thereof will be omitted here.

The input unit 1810 acquires the image data from the analysis device 120. In addition, when notified by the determination unit 1820 of the determination result that the alteration of the image data is to be involved, the input unit 1810 notifies the analysis unit 1230 and the image data alteration unit 1240 of the acquired image data. In this case, the image data alteration unit 1240 alters the image data based on the alteration information and transmits the altered image data to the image compression device 130.

In addition, when notified by the determination unit 1820 of the determination result that the alteration of the image data is not to be involved, the input unit 1810 notifies the image data alteration unit 1240 of the acquired image data. In this case, the image data alteration unit 1240 transmits the image data to the image compression device 130 without altering the image data.

The determination unit 1820 monitors the aggregated value graph (an example of information that relates to the recognition accuracy of the image data) of each block transmitted from the analysis device 120 and determines whether or not the alteration of the image data is to be involved. When it is determined that the alteration of the image data is to be involved, the determination unit 1820 notifies the input unit 1810 of the determination result. On the other hand, when it is determined that the alteration of the image data is not to be involved, the determination unit 1820 notifies the input unit 1810 of the determination result.

<Flow of Image Compression Process by Compression Processing System>

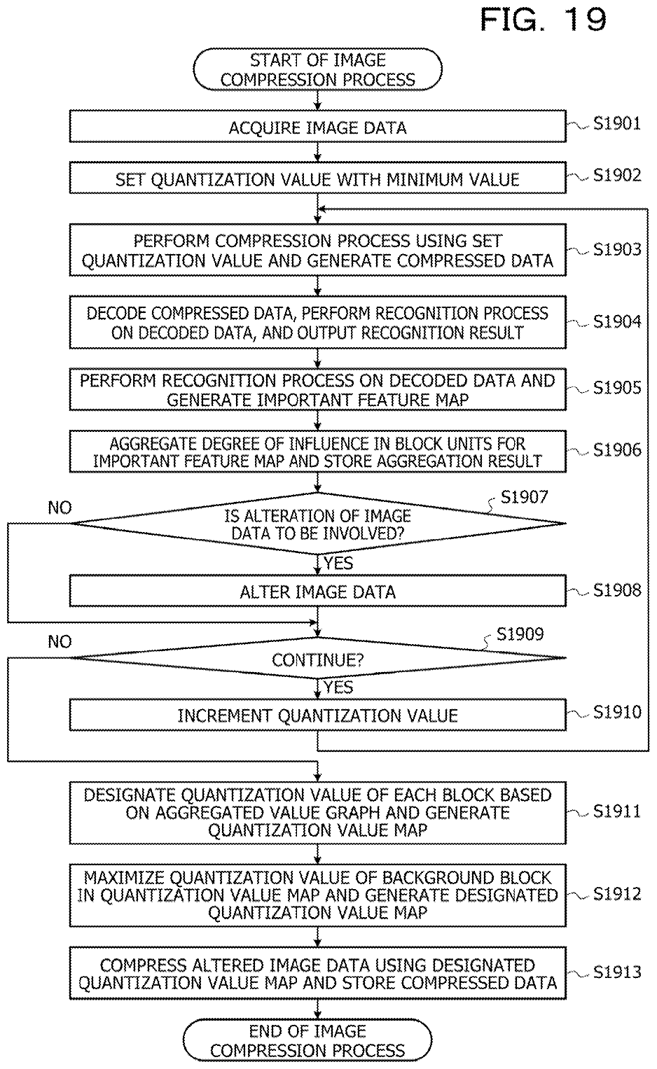

Next, a flow of an image compression process by the compression processing system 1600 will be described. FIG. 19 is a third flowchart illustrating an example of the flow of the image compression process by the compression processing system.

In step S1901, an input unit 310 of the analysis device 120 acquires image data.

In step S1902, a quantization value setting unit 330 of the analysis device 120 transmits the quantization value map (variable) in which the minimum quantization value (Q₁) is set, to the image compression device 130.

In step S1903, the image compression device 130 performs the compression process on the image data using the transmitted quantization value map (variable) and generates the compressed data.

In step S1904, the input unit 310 of the analysis device 120 decodes the generated compressed data. In addition, a CNN unit 320 of the analysis device 120 performs the recognition process on the decoded data.

In step S1905, an important feature map generation unit 350 of the analysis device 120 generates the important feature map indicating the degree of influence of each area on the recognition result, based on the CNN unit structure information.

In step S1906, an aggregation unit 360 of the analysis device 120 aggregates the degree of influence of each area in block units, based on the important feature map. In addition, the aggregation unit 360 of the analysis device 120 stores the aggregation result in an aggregation result storage unit 390 in association with the current compression level (quantization value) and additionally, transmits the aggregated value graph to the data processing device 1610.

In step S1907, the determination unit 1820 of the data processing device 1610 monitors the aggregated value graph of each block transmitted from the analysis device 120 and determines whether or not the alteration of the image data is to be involved.

When it is determined in step S1907 that the alteration of the image data is to be involved (Yes in step S1907), the input unit 1810 is notified of the determination result, and the process proceeds to step S1908.

In step S1908, the input unit 1810 of the data processing device 1610 notifies the analysis unit 1230 and the image data alteration unit 1240 of the image data, and the analysis unit 1230 notifies the image data alteration unit 1240 of the alteration information. In addition, the image data alteration unit 1240 alters the image data based on the alteration information and transmits the altered image data to the image compression device 130.

Alternatively, the input unit 1810 of the data processing device 1610 notifies the analysis unit 1230 of the image data, and the analysis unit 1230 notifies the image data alteration unit 1240 of the score-maximized refined image. In addition, the image data alteration unit 1240 transmits the score-maximized refined image to the image compression device 130 as altered image data.

On the other hand, when it is determined in step S1907 that the alteration of the image data is not to be involved (in the case of No in step S1907), the input unit 1810 is notified of the determination result. In this case, the input unit 1810 of the data processing device 1610 notifies the image data alteration unit 1240 of the image data, and the image data alteration unit 1240 transmits the image data to the image compression device 130 without altering the image data.

In step S1909, the quantization value setting unit 330 of the analysis device 120 determines whether or not to set the next quantization value, and when it is determined that the next quantization value is to be set (Yes in step S1909), the process proceeds to step S1910.

In step S1910, the quantization value setting unit 330 of the analysis device 120 transmits the quantization value map (variable) in which the next quantization value is set, to the image compression device 130 and then returns to step S1903.

On the other hand, when it is determined in step S1909 that the next quantization value is not to be set (in the case of No in step S1909), the process proceeds to step S1911.

In step S1911, a quantization value designation unit 370 of the analysis device 120 designates the quantization value in block units based on the aggregated value graph read from the aggregation result storage unit 390 and generates the quantization value map.

In step S1912, a foreground determination unit 380 of the analysis device 120 maximizes the quantization value set in the background block in the generated quantization value map and generates the designated quantization value map.

In step S1913, the image compression device 130 performs the compression process on the altered image data, using the designated quantization value map and stores the compressed data in the storage device 150.

As is clear from the above description, the data processing device according to the third embodiment determines whether or not the alteration of the image data is to be involved, by monitoring the aggregated value graph of each block in the course of increasing the quantization value when the designated quantization value map is generated. In addition, when it is determined that the alteration of the image data is to be involved, the data processing device according to the third embodiment alters the image data such that the score information is maximized.

By altering the image data itself in this manner as in the second embodiment, according to the third embodiment, the recognition accuracy may be improved even when image data having low recognition accuracy is acquired.

In addition, according to the third embodiment, since the designated quantization value map is generated based on the altered image data, the designated quantization value map in which a high quantization value is set may be generated.

Consequently, according to the third embodiment, the compression level may be improved while the recognition accuracy is improved, as in the second embodiment. For example, according to the data processing device according to the third embodiment, a compression process suitable for the image recognition process by AI may be implemented.

### Fourth Embodiment

In the third embodiment described above, a case has been described in which, in generating the designated quantization value map, it is determined whether or not the alteration of the image data is to be involved, by monitoring the aggregated value graph of each block.

In contrast to this, in a fourth embodiment, it is determined whether or not the alteration of the image data is to be involved, by confirming the recognition accuracy of compressed data after the compression process is performed using the generated designated quantization value map.

Consequently, according to the fourth embodiment, the compression level may be improved while the recognition accuracy is improved, as in the third embodiment. The fourth embodiment will be described below focusing on differences from each embodiment described above.

<System Configuration of Compression Processing System>

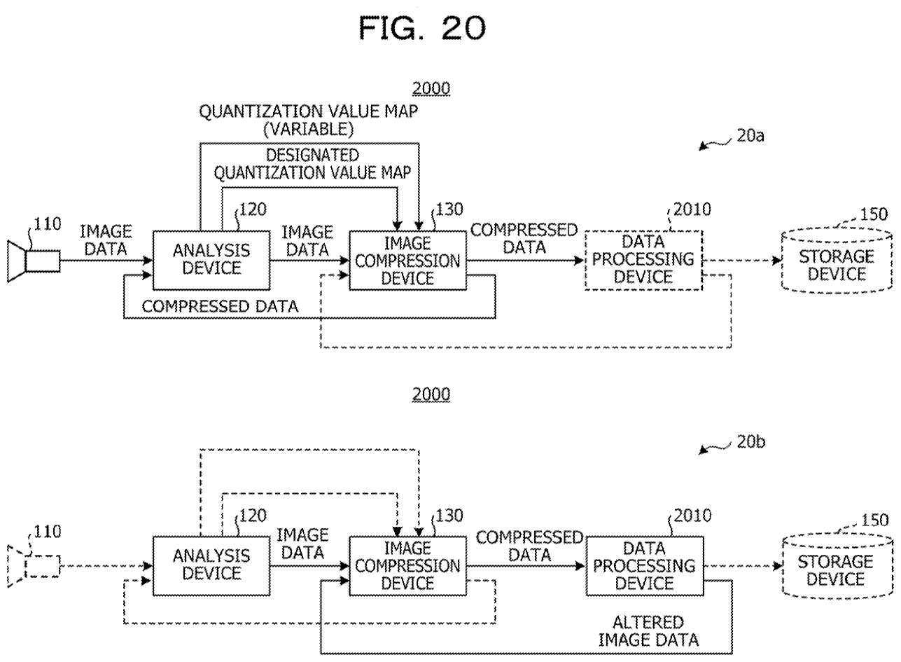

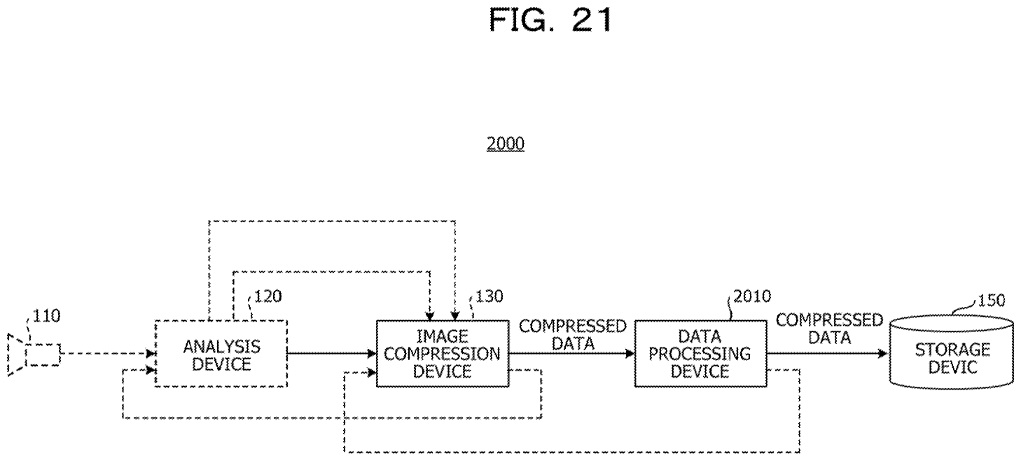

First, a system configuration of the entire compression processing system including a data processing device according to the fourth embodiment will be described. FIGS. 20 and 21 are fifth and sixth diagrams illustrating an example of the system configuration of the compression processing system. In the fourth embodiment, the processing executed by the compression processing system can be roughly divided into:
a first phase of generating a designated quantization value map and performing a compression process using the generated designated quantization value map;
a second phase of confirming the recognition accuracy of compressed data and altering the image data; and
a third phase of performing the compression process on the altered image data and storing the compressed data.

In FIG. 20, a system configuration of a compression processing system 2000 in the first phase is indicated by 20a, and a system configuration of the compression processing system in the second phase is indicated by 20b. In addition, FIG. 21 illustrates a system configuration of the compression processing system in the third phase.

As illustrated in 20a of FIG. 20, the compression processing system 2000 in the first phase includes an imaging device 110, an analysis device 120, and an image compression device 130. Note that, since the processing by the imaging device 110 in the first phase is the same as the processing by the imaging device 110 described with reference to 1a of FIG. 1 in the above first embodiment, the description thereof will be omitted here.

In addition, since the processing by the analysis device 120 and the image compression device 130 in the first phase is similar to the processing by the analysis device 120 and the image compression device 130 described with reference to 11b of FIG. 11 in the above second embodiment, the description thereof will be omitted here.

Meanwhile, as illustrated in 20b of FIG. 20, the compression processing system 2000 in the second phase includes the analysis device 120, the image compression device 130, and a data processing device 2010. Among these, since the processing by the analysis device 120 and the image compression device 130 is similar to the processing by the analysis device 120 and the image compression device 130 described with reference to 11b of FIG. 11 in the above second embodiment, the description thereof will be omitted here.

In 20b of FIG. 20, the data processing device 2010 decodes the compressed data transmitted from the image compression device 130 and performs a recognition process on the decoded data. In addition, the data processing device 2010 determines whether or not the score information included in the recognition result satisfies a predetermined condition and, when it is determined that the predetermined condition is not satisfied, alters the image data such that the score information is maximized and transmits the altered image data to the image compression device 130.

In addition, as illustrated in FIG. 21, the compression processing system 2000 in the third phase includes the image compression device 130, the data processing device 2010, and a storage device 150.

As illustrated in FIG. 21, the image compression device 130 in the third phase performs the compression process on the altered image data transmitted from the data processing device 2010, using the designated quantization value map and transmits the compressed data to the data processing device 2010.

In addition, as illustrated in FIG. 21, the data processing device 2010 in the third phase decodes the compressed data transmitted from the image compression device 130 and performs the recognition process on the decoded data. In addition, the data processing device 2010 determines whether or not the score information included in the recognition result satisfies a predetermined condition and, when it is determined that the predetermined condition is satisfied, stores the compressed data in the storage device 150.

<Functional Configuration of Data Processing Device>

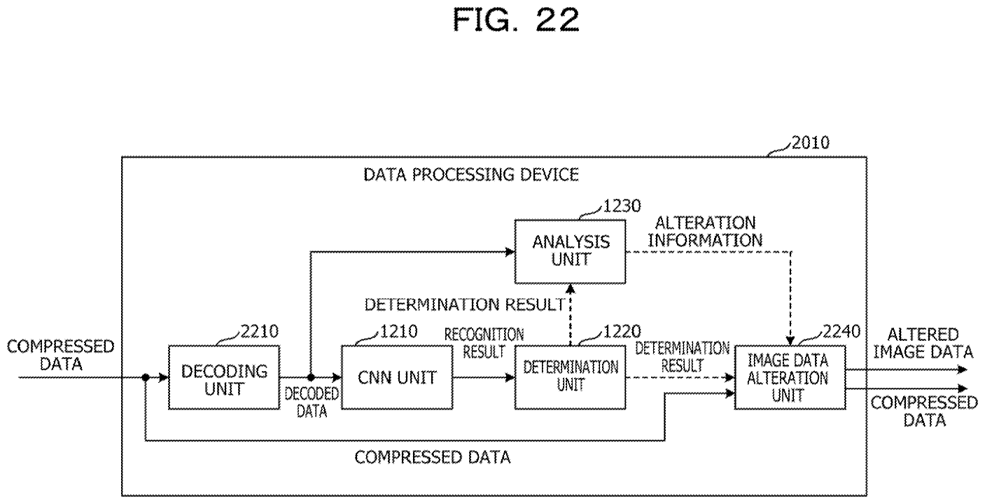

Next, a functional configuration of the data processing device 2010 will be described. FIG. 22 is a fourth diagram illustrating an example of the functional configuration of the data processing device. Similar to the second embodiment described above, the data processing program is installed in the data processing device 2010, and when the program is executed, the data processing device 2010 functions as a decoding unit 2210, a CNN unit 1210, and a determination unit 1220. In addition, the data processing device 2010 functions as an analysis unit 1230 and an image data alteration unit 2240.

Among these, since the CNN unit 1210, the determination unit 1220, and the analysis unit 1230 have functions similar to the functions of the CNN unit 1210, the determination unit 1220, and the analysis unit 1230 described with reference to FIG. 12 in the above second embodiment, the description thereof will be omitted.

The decoding unit 2210 decodes the compressed data transmitted from the image compression device 130 and generates the decoded data. In addition, the decoding unit 2210 notifies the CNN unit 1210 of the decoded data. Furthermore, the decoding unit 2210 notifies the analysis unit 1230 of the decoded data in response to an instruction from the analysis unit 1230.

The image data alteration unit 2240 is an example of the alteration unit. When notified of the determination result by the determination unit 1220, the image data alteration unit 2240 transmits the compressed data to the storage device 150.

In addition, when notified of the alteration information by the analysis unit 1230, the image data alteration unit 2240 alters the image data based on the notified alteration information and transmits the altered image data to the image compression device 130. Alternatively, when notified of the altered image data by the analysis unit 1230, the image data alteration unit 2240 transmits the altered image data to the image compression device 130.

<Flow of Image Compression Process by Compression Processing System>

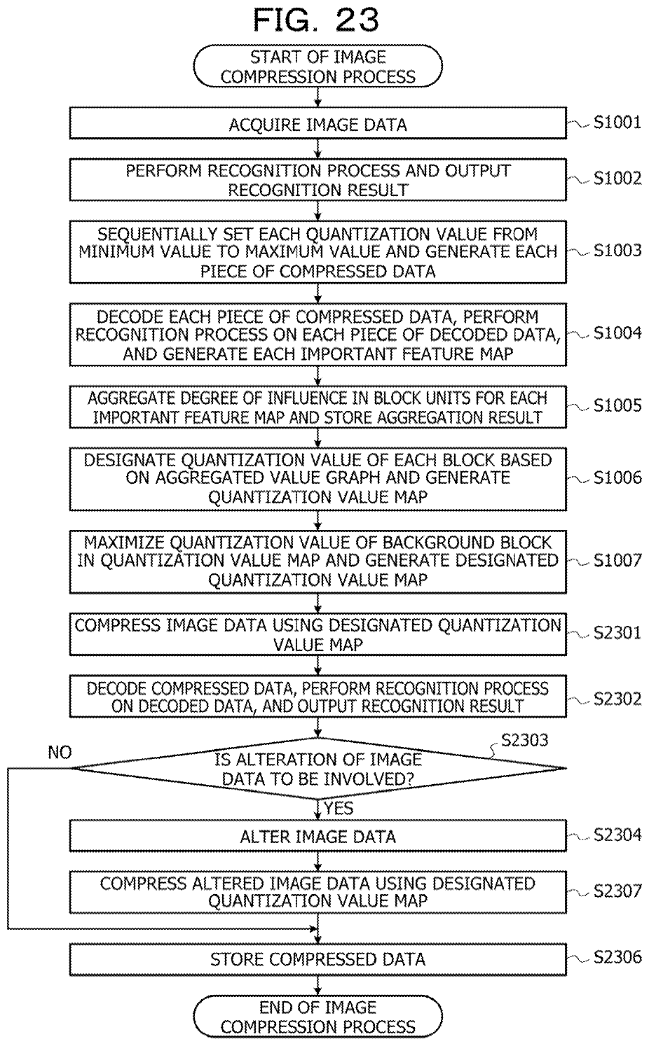

Next, a flow of an image compression process by the compression processing system 2000 will be described. FIG. 23 is a fourth flowchart illustrating an example of the flow of the image compression process by the compression processing system.

In FIG. 23, since steps S1001 to S1007 are similar processes to the processes in steps S1001 to S1007 in FIG. 10, the description thereof will be omitted, and here, the processes in steps S2301 to S2306 will be described.

In step S2301, the image compression device 130 performs the compression process on the image data using the designated quantization value map and generates the compressed data.

In step S2302, the decoding unit 2210 of the data processing device 2010 decodes the compressed data, and the CNN unit 1210 of the data processing device 2010 performs the recognition process on the decoded data to output the recognition result.

In step S2303, the determination unit 1220 of the data processing device 2010 determines whether or not the alteration of the image data is to be involved, by determining whether or not the score information included in the recognition result satisfies a predetermined condition.

When it is determined in step S2303 that the predetermined condition is not satisfied (in the case of Yes in step S2303), it is determined that the alteration of the image data is to be involved, and the process proceeds to step S2304.

In step S2304, the analysis unit 1230 of the data processing device 2010 generates the alteration information for altering the image data such that the score information is maximized. In addition, the image data alteration unit 2240 of the data processing device 2010 alters the image data based on the generated alteration information and transmits the altered image data to the image compression device 130.

Alternatively, the analysis unit 1230 of the data processing device 2010 generates the score-maximized refined image by altering the image data such that the score information is maximized, and notifies the image data alteration unit 2240 of the generated score-maximized refined image. In addition, the image data alteration unit 2240 of the data processing device 2010 transmits the score-maximized refined image to the image compression device 130 as altered image data.

In step S2307, the image compression device 130 performs the compression process on the altered image data using the designated quantization value map and generates the compressed data.

On the other hand, when it is determined in step S2303 that the predetermined condition is satisfied (in the case of No in step S2303), it is determined that the alteration of the image data is not to be involved, and the process proceeds to step S2306 without altering the image data.

In step S2306, the data processing device 2010 stores the compressed data in the storage device 150.

As is clear from the above description, the data processing device according to the fourth embodiment acquires the compressed data when the compression process is performed using the generated designated quantization value map and performs the recognition process on the decoded data obtained by decoding the acquired compressed data. In addition, the data processing device according to the fourth embodiment determines whether or not the score information included in the recognition result satisfies a predetermined condition and, when it is determined that the predetermined condition is not satisfied, alters the image data such that the score information is maximized. Furthermore, the data processing device according to the fourth embodiment stores the compressed data when the compression process is performed on the altered image data using the designated quantization value map.

In this manner, according to the fourth embodiment, since the recognition accuracy of the compressed data is confirmed, and the image data is altered when the alteration of the image data has to be involved, the output of compressed data having low recognition accuracy may be avoided. Consequently, according to the fourth embodiment, the recognition accuracy may be improved while the compression level is improved. For example, according to the data processing device according to the fourth embodiment, a compression process suitable for the recognition process by AI may be implemented.

### Other Embodiments

In the above first embodiment, description has been given assuming that, after the designated quantization value map is generated, it is determined whether each block is a foreground block or a background block, and the quantization value of the block is maximized when it is determined to be a background block. However, the processing order between the process of generating the designated quantization value map and the process of maximizing the quantization value of the background block is not limited to this, and the process of generating the designated quantization value map may be performed after the process of maximizing the quantization value of the background block is performed.

In addition, in the above first embodiment, the process of maximizing the quantization value of the block has been described as being performed when it is determined to be a background block, but a process of invalidating the image data of the background block (for example, a process of making the pixel value zero) may be performed. Alternatively, a low-pass filter process such as blurring may be performed on the image data of the background block.

In addition, in the above first embodiment, the image data referred to by the image compression device 130 when performing the compression process on the image data is not particularly mentioned, but the image data to be referred to may be image data on which the compression process using the corrected designated quantization value map has been performed. Alternatively, the image data to be referred to may be image data on which the compression process has been performed using another quantization value map that produces a degree of deterioration to the same extent as when the compression process is performed using the corrected designated quantization value map.

In addition, in the above first embodiment, the permissible range defined based on the recognition result with respect to the image data has been described as being used as the predetermined second condition for determining whether or not to continue the process of increasing the quantization value, but the predetermined second condition is not limited to this.

For example, among pieces of image data, there can be a sort of image data in which a compression level equal to or higher than a predetermined compression level may not be expected as the compression level when the compression process is performed. For such image data, the permissible range may be defined based on the recognition result with respect to the compressed data when the compression process is performed at a predetermined compression level (quantization value).

In addition, in the above first embodiment, the recognition result with respect to the image data has been described as being used when the permissible range is defined. However, information used when defining the permissible range is not limited to the recognition result with respect to the image data, and for example, annotation information attached to the image data may be used.

In addition, in the above first embodiment, the quantization value used when the image compression device 130 performs the compression process has been described as being provided by the data processing device 140. However, the data processing device 140 may provide a weighting index for adjusting the quantization value used when the image compression device 130 performs the compression process, and the image compression device 130 may adjust the quantization value based on the provided weighting index.

For example, as in the aggregated value or the like of each block, a statistical value for each block obtained by statistically processing the degree of influence on the recognition result for each block, or the amount of change in a statistical value for each block, or the quantization value of each block of the designated quantization value map may be regarded as the weighting index of each block.

Then, for example, the image compression device 130 may adjust the quantization value of each block designated based on an algorithm for controlling the bit rate, using the weighting index. Alternatively, for example, the image compression device 130 may adjust the quantization value of each block set fixedly within a frame or over a plurality of frames, using the weighting index.

As an example, when the quantization value of each block of the designated quantization value map is regarded as a weighting index of each block, for a block having a large quantization value in the designated quantization value map, the image compression device 130 may make the strength of adjustment higher when making adjustments in a direction of raising
each quantization value designated based on an algorithm for controlling the bit rate, or
the quantization value of each block set fixedly within a frame or over a plurality of frames,
and may make the strength of adjustment lower when making adjustments in a direction of lowering the above quantization value.

In addition, as another example, when the aggregated value of each block is regarded as a weighting index of each block, for a block having a large aggregated value, the image compression device 130 may make the strength of adjustment higher when making adjustments in a direction of raising
each quantization value designated based on an algorithm for controlling the bit rate, or
the quantization value of each block set fixedly within a frame or over a plurality of frames,

and may make the strength of adjustment lower when making adjustments in a direction of lowering the above quantization value.

Furthermore, the image compression device 130 may further alter a quantization value that is
the quantization value of each block designated based on an algorithm for controlling the bit rate, or
the quantization value of each block set fixedly within a frame or over a plurality of frames,

and is adjusted using the weighting index, according to other information. Other information mentioned here includes a change and a transition status of a value that affects the recognition accuracy, such as the score information, a classification probability, error information, or object position information when the compressed data is decoded and the recognition process is performed. Note that the image compression device 130 is assumed to alter the quantization value such that the value that affects the recognition accuracy is maintained or enhanced, or falls within a predetermined permissible range of degradation. In addition, the image compression device 130 is assumed to perform the compression process on the corresponding image data or image data acquired after the corresponding image data, using the altered quantization value. Alternatively, the image compression device 130 is assumed to perform the compression process on a plurality of pieces of image data including the corresponding image data and the image data acquired after the corresponding image data, using the altered quantization value.

In addition, in the above second to fourth embodiments, the number of objects included in the image data to be altered is not mentioned, but a plural number of objects may be included in the image data to be altered. In this case, the data processing device may alter the image data for each object such that the score information of every object is maximized, or may alter the image data collectively for a plurality of objects such that the score information of the plurality of objects is maximized.

In addition, in the above second to fourth embodiments, the score-maximized refined image data has been described as being generated when the image data is altered. However, for example, in the case of confirming the recognition accuracy of the decoded data and altering the decoded data when the recognition accuracy is low, as in the fourth embodiment described above, when there is
decoded data or image data having higher recognition accuracy than the recognition accuracy of the decoded data determined to have lower recognition accuracy, which is
decoded data or image data different from the decoded data determined to have low recognition accuracy,

the decoded data or image data having higher recognition accuracy may be used instead of generating the score-maximized refined image. This allows omission of the process of generating the score-maximized refined image.

In addition, in the above second to fourth embodiments, the score-maximized refined image data has been described as being generated based on the image data or the decoded data. However, before the score-maximized refined image is generated, the background block may be determined, and an invalidation process or image processing such as a low-pass filter process may be performed on the image data or the decoded data of the determined background block.

In addition, in each of the above embodiments, the compression process has been described as being performed by targeting the image data transmitted from the imaging device 110. However, the target of the compression process is not limited to this, and for example, the compression process may be performed by targeting image data obtained by resizing the image data transmitted from the imaging device 110 to a predetermined size.

In addition, in each of the above embodiments, the size of each block is not particularly mentioned, but the size of each block may be a fixed size or may be a variable size. In addition, in the case of the variable size, the size may be according to the magnitude of the quantization value, for example.

Note that the embodiments are not limited to the configurations described here and may include, for example, combinations of the configurations or the like described in the above embodiments with other elements. These points can be altered without departing from the spirit of the embodiments and can be appropriately assigned according to application modes thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing device comprising:
a memory; and
a processor coupled to the memory and configured to:
in a case where a compression level is designated based on a degree of influence of each block on a recognition result when a recognition process is performed on image data, generate compressed data by performing a compression process on the image data by using the compression level; and
in a case where the recognition result when the recognition process is performed on decoded data obtained by decoding the compressed data satisfies a predetermined condition, correct a block that corresponds to a recognition target, in a direction of raising the compression level.

2. The data processing device according to claim 1, wherein, in a case where the recognition result when the recognition process is performed on the decoded data obtained by decoding the compressed data does not satisfy the predetermined condition,
the processor corrects the block that corresponds to the recognition target, in the direction of lowering the compression level.

3. The data processing device according to claim 1, wherein, by comparing score information included in the recognition result when the recognition process is performed on the decoded data obtained by decoding the compressed data, and a predetermined threshold value,
the processor determines whether or not the recognition result satisfies the predetermined condition.

4. The data processing device according to claim 1, wherein, by comparing score information included in the recognition result when the recognition process is performed on the image data, and the score information included in the recognition result when the recognition process is performed on the decoded data obtained by decoding the compressed data,
the processor determines whether or not the recognition result satisfies the predetermined condition.

5. The data processing device according to claim 1, wherein
the processor outputs the corrected compression level when a correction is made in the direction of raising the compression level of the block that corresponds to the recognition target within a range that satisfies the predetermined condition.

6. The data processing device according to claim 2, wherein
the processor outputs the corrected compression level when a correction is made in the direction of lowering the compression level of the block that corresponds to the recognition target until the predetermined condition is satisfied.

7. The data processing device according to claim 5, wherein
the processor outputs the compression level in which the compression level of the block other than the block that corresponds to the recognition target is maximized.

8. A data processing device comprising:
a memory; and
a processor coupled to the memory and configured to:
when image data to be subjected to a compression process is input, acquire information that relates to recognition accuracy of the image data;
determine whether or not alteration of the image data is to be involved, based on the information that relates to the recognition accuracy of the image data;
output the input image data when determining that the alteration of the image data is not to be involved; and
alter the image data and output the altered image data when determining that the alteration of the image data is to be involved.

9. The data processing device according to claim 8, wherein
the processor acquires a recognition result when a recognition process is performed on the image data, as the information that relates to the recognition accuracy of the image data.

10. The data processing device according to claim 8, wherein the processor decodes compressed data; and
acquires the recognition result when a recognition process is performed on the image data generated by decoding the compressed data, as the information that relates to the recognition result of the image data.

11. The data processing device according to claim 9, wherein
the processor determines whether or not the alteration of the image data is to be involved, by comparing score information included in the recognition result, and a predetermined threshold value.

12. The data processing device according to claim 8, wherein
when the compression process is performed on the image data at different compression levels, and
each piece of compressed data is decoded, and a recognition process is performed on each piece of decoded data, and
a degree of influence on a recognition result at a time of each recognition process is aggregated for each block,
the processor acquires an aggregated value for each block, as the information that relates to the recognition result of the image data.

13. The data processing device according to claim 8, wherein
the processor alters the image data such that the score information included in a recognition result when a recognition process is performed on the image data is maximized.

14. The data processing device according to claim 13, wherein the processor analyzes a causative area of erroneous recognition of the image data in pixel units, based on:
a map that indicates an altered part when the image data is altered such that the score information included in the recognition result when the recognition process is performed on the image data is maximized; and
a map that indicates the degree of influence of each area of the altered image data on the recognition result when the recognition process is further performed on the altered image data that has been altered such that the score information included in the recognition result when the recognition process is performed on the image data is maximized.

15. The data processing device according to claim 14,
wherein
the processor generates alteration information configured to alter the causative area in the pixel units, and
alters the causative area in the pixel units, based on the alteration information.

16. A non-transitory computer-readable recording medium soring a data processing program causing a computer to execute a processing comprising:
in a case where a compression level is designated based on a degree of influence of each block on a recognition result when a recognition process is performed on image data, generating compressed data by performing a compression process on the image data by using the compression level; and
in a case where the recognition result when the recognition process is performed on decoded data obtained by decoding the compressed data satisfies a predetermined condition, correcting a block that corresponds to a recognition target, in a direction of raising the compression level.
